(19) United States
(12) Patent Application Publication
(10) Pub. No.: US 2010/0192915 A1
(43) Pub. Date: Aug. 5, 2010

(54) VARIABLE STROKE CHARACTERISTIC ENGINE

(75) Inventors: Shigekazu Tanaka, Wako (JP); Koichi Eto, Wako-shi (JP); Akinori Maezuru, Wako (JP); Jiro Fujimoto, Wako-shi (JP); Keiko Yoshida, Wako-shi (JP); Taichi Yoshikawa, Wako (JP)

Correspondence Address: LAHIVE & COCKFIELD, LLP;FLOOR 30, SUITE 3000, ONE POST OFFICE SQUARE, BOSTON, MA, 02109, US

(73) Assignee: Honda Motor Co., Ltd., Tokyo (JP)

(21) Appl. No.: 12/440,136

(22) PCT Filed: Sep. 4, 2007
(86) PCT No.: PCT/JP2007/067220

§ 371 Date: Mar. 5, 2009

(30) Foreign Application Priority Data
Sep. 12, 2006 (JP) 2006-247263
Sep. 19, 2006 (JP) 2006-253135
Sep. 25, 2006 (JP) 2006-259577
Sep. 25, 2006 (JP) 2006-259579
Sep. 25, 2006 (JP) 2006-259580
Sep. 25, 2006 (JP) 2006-259581

(51) Int. Cl. F02B 75/04

(52) U.S. Cl. 123/48 B

(57) ABSTRACT

A variable stroke characteristic engine in which a piston (11) and a crankshaft (30) are linked to a control shaft (65) via a variable stroke link mechanism (LV), and the variable stroke link mechanism (LV) is operated by a hydraulic actuator (AC) that drives the control shaft (65) to thus make the stroke travel of the piston (11) variable, in which the hydraulic actuator (AC) is formed from a housing (HU), a cover member covering an aperture of the housing (HU), a vane case provided integrally within the housing (HU), and a vane shaft (66) housed within the vane case, and the vane shaft (66) is formed integrally with the control shaft (65). The number of components of the actuator (AC) can be decreased, and its ease of assembly can be improved.

### TECHNICAL FIELD

The present invention relates to an improvement of a variable stroke characteristic engine in which a piston and a crankshaft are linked to a control shaft via a variable stroke link mechanism, and the variable stroke link mechanism is operated by a hydraulic actuator that drives the control shaft to thus make the stroke travel of the piston variable.

### BACKGROUND ART

Conventionally, there is a known a variable stroke characteristic engine that includes a variable stroke link mechanism formed from an upper link having one end linked to a piston pin of a piston, a lower link linked to the other end of the upper link and linked to a crankpin of a crankshaft, and a control link having one end linked to the lower link and the other end swingably linked to an engine main body, in which the stroke travel of the piston is made variable by driving the variable control link by a hydraulic actuator, the hydraulic actuator being provided on a control shaft (ref. Patent Publication 1 below).

Furthermore, there is also a known variable stroke characteristic engine that includes a variable stroke link mechanism formed from an upper link having one end linked to a piston pin of a piston, a lower link linked to the other end of the upper link and linked to a crankpin of a crankshaft, and a control link having one end linked to the lower link and the other end swingably linked to a control shaft, in which the travel stroke of the piston is made variable by the drive of a vane type hydraulic actuator provided on the control shaft (ref. Patent Publications 2 and 3 below).

### Patent Publication 1: Japanese Patent Application Laid-open No. 2005-83203

### Patent Publication 2: Japanese Patent Application Laid-open No. 2005-76555

### Patent Publication 3: Japanese Patent Application Laid-open No. 2006-177192

### DISCLOSURE OF INVENTION

### Problems to be Solved by the Invention

Since the hydraulic actuator of the conventional variable stroke characteristic engine is provided on the exterior of a cylinder block and is formed from a housing fixed to a holder portion of the cylinder block by a securing member, a vane-equipped rotor rotating integrally with a control shaft, a vane case housing the rotor, a cover covering the vane case, etc., this gives rise to the problems that the number of components is large, the ease of assembly is degraded, and the dimensions of the engine itself increase, and this engine is not suitable for use in a vehicle.

Furthermore, in such a variable stroke characteristic engine, a vane type hydraulic actuator is used for driving a variable stroke link mechanism, but since this actuator is formed with a housing for accommodating a vane shaft, a vane oil chamber, etc. so as to have a relatively large occupancy volume in the radial direction and, moreover, it is linked to a crankshaft via the variable stroke link mechanism, if this actuator is provided within a crank chamber, there is the problem that the dimensions of the engine main body increase in the width direction, that is, in a direction that intersects the crankshaft; furthermore, if, in order to improve the rigidity with which this actuator is supported, it is supported by a high rigidity member, the above problem becomes more noticeable, and when this engine is used for an automobile, the width in the fore-and-aft direction of an engine compartment (when the engine is transversely mounted) or the width in the left-and-right direction (when the engine is longitudinally mounted) inevitably increases.

Furthermore, with regard to the vane type hydraulic actuator, since the occupancy volume in the radial direction is formed so as to be relatively large with a cylindrical housing that accommodates a vane shaft, a vane oil chamber, etc., if this actuator is provided within the crank chamber, there is the problem that the dimensions of the engine increase, and the height in particular increases; furthermore, in order to enhance the rigidity with which the actuator is supported, if this actuator is supported by a high rigidity member, the above problem becomes more noticeable, and when this engine is used for an automobile, the height of an engine compartment inevitably increases.

Furthermore, when such a variable stroke characteristic engine is running, since a maximum load acts on the control shaft via a control link toward a point where a lower link and the control link of the variable stroke link mechanism are linked, if a vane type hydraulic actuator is provided coaxially with the control shaft, the maximum load acts on the control shaft in the radial direction, the vane interferes with the housing in the direction of the maximum load, and there is a possibility that, for example, ‘galling’ will occur; in order to prevent this interference, it is necessary to increase the radial clearance between the vane and the housing, and if this is done there is the problem that the performance of the hydraulic actuator is degraded.

Moreover, when such an engine is running, since the maximum load (the load when made to run in a low compression ratio state) acts on the control shaft via the control link toward the point where the lower link and the control link of the variable stroke link mechanism are linked, if the vane type actuator is provided coaxially with the control shaft, the maximum load acts on the control shaft and the vane shaft of the actuator to thus increase friction between bearing faces of the vane shaft and the control shaft, and there is the problem that the driving force increases by a portion corresponding thereto; there is also the problem that an oil film break might occur on bearing faces of the vane shaft and the control shaft, thus causing metal contact.

The present invention has been accomplished in the light of such circumstances, and it is an object thereof to provide a novel actuator structure for a variable stroke characteristic engine that enables a hydraulic actuator of the above type to be made small and lightweight by reducing the number of components thereof, suppresses any increase in the dimensions of the engine, enhances the rigidity with which it is supported, enables the radial clearance between a vane and a housing to be set as small as possible, and enables such a maximum load imposed on bearing faces of control and vane shafts of a vane type hydraulic actuator to be reduced, thus solving the above various problems.

### Means for Solving the Problems

In order to attain the above object, according to a first aspect of the present invention, there is provided a variable stroke characteristic engine in which a piston and a crankshaft are linked to a control shaft via a variable stroke link mechanism, and the variable stroke link mechanism is operated by a hydraulic actuator that drives the control shaft to thus make the stroke travel of the piston variable, characterized in that the hydraulic actuator comprises a housing, a cover member covering an aperture of the housing, a vane case provided integrally within the housing, and a vane shaft housed within the vane case, and the vane shaft is formed integrally with the control shaft.

In order to attain the above object, according to a second asect of the present invention, there is provided a variable stroke characteristic engine in which a piston and a crankshaft are linked to a control shaft via a variable stroke link mechanism, and the variable stroke link mechanism is operated by a hydraulic actuator that drives the control shaft to thus make the stroke travel of the piston variable, characterized in that the hydraulic actuator comprises a housing, a cover member covering an aperture of the housing, a vane case provided integrally within the housing, and a vane shaft housed within the vane case, and the hydraulic actuator is provided on an end part of the control shaft, and the vane shaft is formed integrally with the end part of the control shaft.

In order to attain the above object, according to a third aspect of the present invention, there is provided a variable stroke characteristic engine in which a piston and a crankshaft are linked to a control shaft via a variable stroke link mechanism, and the variable stroke link mechanism is operated by a hydraulic actuator that drives the control shaft to thus make the stroke travel of the piston variable, characterized in that the hydraulic actuator comprises a housing, a cover member covering an aperture of the housing, a vane case provided integrally within the housing, and a vane shaft housed within the vane case, and the hydraulic actuator is provided between mutually opposing connecting end parts of a divided control shaft, and the cover member and the vane shaft are formed integrally with the control shaft.

In order to attain the above object, according to a fourth aspect of the present invention, in addition to the third aspect, the cover member and the vane shaft are secured integrally by a securing member at a position not overlapping an eccentric pin of the control shaft.

In order to attain the above object, according to a fifth aspect of the present invention, in addition to the third or fourth aspect, the cover member is bearingly supported on the housing.

In order to attain the above object, according to a sixth aspect of the present invention, in addition to the first, second or third aspect, the variable stroke link mechanism is disposed to one side of the crankshaft and the hydraulic actuator is a vane type hydraulic actuator disposed coaxially with the control shaft, wherein the vane type hydraulic actuator comprises the housing, the vane shaft, which is integral with the control shaft rotatably provided in the housing and has a vane projectingly provided on the outer periphery, and a pair of vane oil chambers between the housing and the vane shaft, the vane oil chambers housing the vane, and the pair of vane oil chambers are arranged in a cylinder axis direction of an engine main body of the variable stroke characteristic engine.

In order to attain the above object, according to a seventh aspect of the present invention, in addition to the sixth aspect, the housing of the vane type hydraulic actuator is provided within a crankcase, the housing and the crankcase are secured by a plurality of transverse securing members from a direction perpendicular to the cylinder axis of the engine main body, and at least some of these securing members are provided between the pair of vane oil chambers arranged in the cylinder axis direction.

In order to attain the above object, according to an eighth aspect of the present invention, in addition to the sixth or seventh aspect, the housing of the vane type hydraulic actuator and the cover member covering the aperture of the housing are secured by a plurality of crankshaft-direction securing members extending in the crankshaft direction, and some of these crankshaft-direction securing members are provided between the transverse securing members.

In order to attain the above object, according to a ninth aspect of the present invention, in addition to the seventh or eighth aspect, a hydraulic passage supplying hydraulic oil to the pair of vane oil chambers is provided in the housing so as to be displaced in the crankshaft direction with respect to the transverse securing member.

In order to attain the above object, according to a tenth aspect of the present invention, in addition to the sixth, seventh, eighth or ninth aspect, the cylinder axis of the engine main body is inclined toward one side relative to a vertical line, and the vane type hydraulic actuator is provided on the other side within a crankcase beneath the crankshaft.

In order to attain the above object, according to an eleventh aspect of the present invention, in addition to the first, second or third aspect, the hydraulic actuator is disposed beneath the crankshaft and comprises the housing, the vane shaft that is integral with the control shaft rotatably provided on the housing and has a vane projectingly provided on the outer periphery, and a pair of vane oil chambers between the housing and the vane shaft, the vane oil chambers housing the vane, and the pair of vane oil chambers are arranged in a direction perpendicular to a cylinder axis of an engine main body of the variable stroke characteristic engine.

In order to attain the above object, according to a twelfth aspect of the present invention, in addition to the eleventh aspect, the housing of the vane type hydraulic actuator is supported on a housing receiving part provided integrally with a bearing block supporting the control shaft, and the housing is secured via a securing member to the housing receiving part between the pair of vane oil chambers.

In order to attain the above object, according to a thirteenth aspect of the present invention, in addition to the eleventh or twelfth aspect, the cylinder axis of the engine main body is inclined to one side relative to a vertical line, a crankcase of the engine main body protrudes on one side relative to the cylinder block, and the vane type hydraulic actuator is housed within a crank camber of the protruding portion.

In order to attain the above object, according to a fourteenth aspect of the present invention, in addition to the first, second or third aspect, the hydraulic actuator comprises the housing, the vane shaft rotatably provided in the housing and integral with the control shaft, and a vane provided integrally with the outer periphery of the vane shaft and dividing the interior of a vane oil chamber formed between the housing and the vane shaft into a plurality of control oil chambers, and the vane is provided at a position that avoids the direction of a radial maximum load generated in the vane shaft.

In order to attain the above object, according to a fifteenth aspect of the present invention, in addition to the fourteenth aspect, when the variable stroke characteristic engine is in the lowest low compression ratio state, the vane is disposed in a direction perpendicular to the direction of maximum load.

In order to attain the above object, according to a sixteenth aspect of the present invention, in addition to the fifteenth aspect, the housing of the hydraulic actuator is secured to a housing receiving part of a bearing block in a direction opposite to the direction of maximum load, and a plurality of bearing walls supporting the control shaft and a linking member joining these bearing walls are formed integrally with the bearing block.

The bearing block and the bearing wall may be integrated or may be separate bodies.

In order to attain the above object, according to a seventeenth aspect of the present invention, in addition to any one of the sixth to sixteenth aspects, the vane type hydraulic actuator comprises urging force imparting means for imparting to the vane shaft an urging force in a direction opposite to the direction of maximum load acting on the vane shaft.

In order to attain the above object, according to an eighteenth aspect of the present invention, in addition to the seventeenth aspect, the vane type hydraulic actuator is provided with control oil chambers for rotating the vane shaft through a predetermined angular range, the control oil chambers opposing each other in the radial direction of the vane shaft, a communication oil path communicating with the opposing control oil chambers is provided within the vane shaft in a radial direction, and a communication state between the control oil chamber and the communication oil path is restricted before a limit position in the rotational direction of the vane shaft.

In order to attain the above object, according to a nineteenth aspect of the present invention, in addition to the eighteenth aspect, when the communication state between the opposing control oil chamber on one side and the communication oil path is restricted, the communication state between the control oil chamber on the other side and the communication oil path is maintained, and an oil path of a hydraulic circuit communicates with the control oil chamber on the other side.

In order to attain the above object, according to a twentieth aspect of the present invention, in addition to the nineteenth aspect, a communication passage half on one side of the communication oil path communicating with the opposing control oil chamber on one side and a communication passage half on the other side of the communication oil path communicating with the opposing control oil chamber on the other side are each formed linearly, and the communication passage half on the other side is formed so as to bend relative to the communication passage half on the one side at a predetermined angle in a central part of the vane shaft.

### EFFECTS OF THE INVENTION

In accordance with the first aspect of the present invention, it becomes possible to reduce the number of components of the hydraulic actuator provided on the control shaft, thus making it small and lightweight and, moreover, it is possible to improve the ease of assembly of the hydraulic actuator.

In accordance with the second aspect of the present invention, it becomes possible to reduce the number of components of the hydraulic actuator provided on the control shaft, thus making it small and lightweight and, moreover, it is possible to improve the ease of assembly of the hydraulic actuator.

In accordance with the third aspect of the present invention, it becomes possible to reduce the number of components of the hydraulic actuator provided on the control shaft, thus making it small and lightweight and, moreover, it is possible to improve the ease of assembly of the hydraulic actuator.

In accordance with the fourth aspect of the present invention, it is possible to bring the hydraulic actuator as close to the shaft center of the control shaft as possible and secure them integrally, thus making the housing still smaller.

In accordance with the fifth aspect of the present invention, it is possible to stably support the hydraulic actuator on the housing.

In accordance with the sixth aspect of the present invention, since the pair of vane oil chambers of the vane type hydraulic actuator are arranged in the cylinder axis direction of the engine main body of the variable stroke characteristic engine, it is possible to suppress any increase in dimensions in the width direction perpendicular to the crankshaft of the engine.

In accordance with the seventh aspect of the present invention, since the housing and the crankcase are secured by a plurality of transverse securing members from a direction perpendicular to the cylinder axis of the engine main body, and at least some of these securing members are provided between the pair of vane oil chambers disposed in the cylinder axis direction, with respect to the housing and the crankcase it is possible to suppress any increase in dimensions of the width of the engine and improve the rigidity with which the vane type hydraulic actuator is supported.

In accordance with the eighth aspect of the present invention, since the housing of the actuator and the cover member covering the aperture of the housing are secured by a plurality of crankshaft-direction securing members extending in the crankshaft direction, and some of these crankshaft-direction securing members are provided between the transverse securing members, it is possible to suppress any increase in dimensions in the width of the engine and improve the rigidity with which the actuator is secured to the housing.

In accordance with the ninth aspect of the present invention, since the hydraulic passage for supplying hydraulic oil to the pair of vane oil chambers is provided in the housing so as to be displaced in the crankshaft direction from the transverse securing members, it is possible to provide the transverse securing members and the hydraulic passage in proximity to each other, and suppression of any increase in dimensions in the engine width direction becomes still more marked.

In accordance with the tenth aspect of the present invention, since the cylinder axis of the engine main body is inclined to one side relative to the vertical line, and on the other side thereof the actuator is provided within the crankcase beneath the crankshaft, it is possible to position the actuator by effectively utilizing dead space secured within the crankcase, and it is possible to suppress both increase in the width dimension of the engine and increase in dimensions in the height direction thereof.

In accordance with the eleventh aspect of the present invention, since the pair of vane oil chambers of the vane type hydraulic actuator are arranged in a direction perpendicular to the cylinder axis of the variable stroke characteristic engine, it is possible to reduce the height of the actuator, thereby suppressing any increase in dimensions in the engine height direction.

In accordance with the twelfth aspect of the present invention, since the housing of the vane type hydraulic actuator is secured by the securing members to the housing receiving part between the pair of vane oil chambers, it is possible to improve the rigidity with which the housing is supported and, moreover, it is possible to reduce the height of a supporting part of the housing, thereby further suppressing any increase in dimensions in the engine height direction.

In accordance with the thirteenth aspect of the present invention, it is possible to suppress any increase in dimensions in the height direction of the engine main body and guarantee the degree of freedom for the range of inclination of the engine.

In accordance with the fourteenth aspect of the present invention, since the vane of the hydraulic actuator is provided at a position that avoids the maximum radial load direction occurring in the vane shaft, it is possible to set the radial clearance between the vane and the vane oil chamber of the housing as small as possible, thus improving the performance of the actuator.

In accordance with the fifteenth aspect of the present invention, since the vane is disposed in a direction perpendicular to its maximum load direction when the variable stroke characteristic engine attains the lowest low compression ratio state, it is possible to still more markedly improve the performance of the actuator.

In accordance with the sixteenth aspect of the present invention, since the housing of the actuator is secured to the housing receiving part of the bearing block in a direction opposite to the maximum load direction, it is possible to still further improve the rigidity of the housing by means of the bearing block; furthermore, since there is no vane oil chamber on the side opposite to the maximum load direction, it is possible to secure the housing and the bearing block yet more firmly and, moreover, it is easy to guarantee the degree of freedom in disposing a securing member such as a securing bolt for securing the bearing block to the housing.

In accordance with the seventeenth aspect of the present invention, since the friction of the bearing face of the vane shaft in the maximum load direction can be reduced, the responsiveness of the actuator improves and, moreover, since any increase in the driving force can be suppressed, it is possible to suppress the possibility of oil film breaks occurring on the bearing face.

In accordance with the eighteenth aspect of the present invention, since the state of communication between the vane oil chamber and the communication oil path provided in the vane shaft is restricted before a rotational direction limit position of the vane shaft of the actuator, it is possible to generate an urging force in a direction opposite to that of the maximum load acting on the vane shaft without adding a structural modification to the oil path arrangement.

In accordance with the nineteenth aspect of the present invention, since hydraulic oil is supplied to the communication oil path provided in the vane shaft without the vane shaft rotating when the actuator is in operation, it is possible to further improve the responsiveness of the vane shaft.

In accordance with the twentieth aspect of the present invention, since the communicating passage half on one side that communicates with the opposing control oil chamber on one side and the communication passage half on the other side that communicates with the opposing control oil chamber on the other side are each formed in a linear shape and, relative to the communication passage half on one side, the communication passage half on the other side is formed so as to bend at a predetermined angle in a central part of the vane shaft, it is possible to form the communication oil path easily with good precision and suppress any degradation in the rigidity of the vane shaft.

### BRIEF EXPLANATION OF DRAWINGS

FIG. 1 is an overall schematic perspective view of a variable stroke characteristic engine (first embodiment).

FIG. 2 is a view from arrow 2 in FIG. 1 (first embodiment).

FIG. 3 is a sectional view along line 3-3 in FIG. 1 (high compression ratio state) (first embodiment).

FIG. 4 is a sectional view along line 4-4 in FIG. 1 (low compression ratio state) (first embodiment).

FIG. 5 is a sectional view along line 5-5 in FIG. 2 (first embodiment).

FIG. 6A is a transverse sectional view along line 6-6 in FIG. 5 (first embodiment).

FIG. 6B is a transverse sectional view along line 6-6 in FIG. 5 (modified example) (first embodiment).

FIG. 7 is an enlarged sectional view along line 7-7 in FIG. 5 (first embodiment).

FIG. 8 is a sectional view along line 8-8 in FIG. 3 (first embodiment).

FIG. 9 is a perspective view from arrow 9 in FIG. 5 (first embodiment).

FIG. 10 is an exploded perspective view of a hydraulic actuator (first embodiment).

FIG. 11 is a hydraulic circuit diagram of a control system of the hydraulic actuator (first embodiment).

FIG. 12 is a sectional side view of a support part for a control shaft (second embodiment).

FIG. 13 is a sectional view along line 13-13 in FIG. 12 (second embodiment).

FIG. 14 is a perspective view of the control shaft and a center bearing member (second embodiment).

FIG. 15 is an exploded view and an assembled perspective view of the control shaft (second embodiment).

FIG. 16 is a partially sectional side view of a control shaft and an actuator (third embodiment).

FIG. 17 is a perspective view of the control shaft (third embodiment).

FIG. 18 is a partially sectional side view of a control shaft and an actuator (fourth embodiment).

FIG. 19 is a sectional view of a vane type hydraulic actuator (fifth embodiment).

FIG. 20 is a partially sectional side view of a variable stroke characteristic engine (sixth embodiment).

FIG. 21 is a partially sectional side view of an engine main body (seventh embodiment).

FIG. 22 is a partially sectional side view of an engine main body (eighth embodiment).

FIG. 23 is a sectional view, corresponding to FIG. 6 of the first embodiment, of a vane type hydraulic actuator (ninth embodiment).

FIG. 24 is a sectional view, corresponding to FIG. 6 of the first embodiment, of a vane type hydraulic actuator (10th embodiment).

FIG. 25 is a diagram for explaining the operation of a vane type hydraulic actuator (11th embodiment).

FIG. 26 is a view, corresponding to FIG. 25, related to a 12th embodiment (12th embodiment).

FIG. 27 is a sectional view, corresponding to FIG. 6 of the first embodiment, of a vane type hydraulic actuator (13th embodiment).

FIG. 28 is a sectional view, corresponding to FIG. 7 of the first embodiment, of the vane type hydraulic actuator (13th embodiment).

FIG. 29 is an overall schematic perspective view of a variable stroke characteristic engine (14th embodiment).

FIG. 30 is a view from arrow 30 in FIG. 29 (14th embodiment).

FIG. 31 is a sectional view along line 31-31 in FIG. 29 (high compression ratio state) (14th embodiment).

FIG. 32 is a sectional view along line 32-32 in FIG. 29 (low compression ratio state) (14th embodiment).

FIG. 33 is a sectional view along line 33-33 in FIG. 30 (14th embodiment).

FIG. 34 is a transverse sectional view along line 34-34 in FIG. 33 (14th embodiment).

FIG. 35 is an enlarged sectional view along line 35-35 in FIG. 33 (14th embodiment).

FIG. 36 is a sectional view along line 36-36 in FIG. 31 (14th embodiment).

FIG. 37 is a schematic perspective view of an engine main body (15th embodiment).

FIG. 38 is a sectional view along line 38-38 in FIG. 39 (15th embodiment).

FIG. 39 is a sectional view along line 39-39 in FIG. 38 (15th embodiment).

FIG. 40 is a sectional view along line 40-40 in FIG. 38 (15th embodiment).

FIG. 41 is a sectional view along line 41-41 in FIG. 38 (15th embodiment).

FIG. 42 is a sectional view of a mounting part of an actuator on an engine main body (16th embodiment).

FIG. 43 is a developed perspective view of a vane type hydraulic actuator (17th embodiment).

FIG. 44 is a perspective view of a rotor (17th embodiment).

FIG. 45 is an enlarged sectional view of an essential part of a vane (17th embodiment).

FIG. 46 is a diagram for schematically explaining the operation (17th embodiment).

FIG. 47 is a developed perspective view of a vane type hydraulic actuator (18th embodiment).

FIG. 48 is a perspective view of a rotor (18th embodiment).

FIG. 49 is an enlarged view when viewing portion 49 in FIG. 47 from the axial direction of the rotor (18th embodiment).

FIG. 50 is a diagram for schematically explaining the operation (18th embodiment).

FIG. 51 is a perspective view of a rotor (19th embodiment).

FIG. 52 is a diagram for schematically explaining the operation (19th embodiment).

FIG. 53 is an enlarged view of an essential part of a vane type hydraulic actuator (20th embodiment).

FIG. 54 is a diagram for schematically explaining the operation (20th embodiment).

### EXPLANATION OF REFERENCE NUMERALS AND SYMBOLS

1 Engine main body
2 Cylinder block
4 Crankcase
11 Piston
30 Crankshaft
56 Transverse securing member (securing bolt)
65 Control shaft
65-1 First control shaft
65-2 Second control shaft
65P Eccentric pin
66 Vane shaft
67 Securing member
70 Bearing block
71 Linking member
72 Bearing wall
73 Housing receiving part
74 Securing member (securing bolt)
79 Vane case
81 Cover member (vane bearing)
82 Cover member (vane bearing)
83 Crankshaft-direction securing member (securing bolt)
86 Vane oil chamber
86a Control oil chamber
86b Control oil chamber
87 Vane
88 Hydraulic passage
89 Hydraulic passage
99 Communication oil path
99A Communication passage half on one side
99B Communication passage half on other side
181 Cover member
182 Cover member
281 Cover member
282 Cover member
381 Cover member
E Variable stroke characteristic engine
AC Hydraulic actuator (vane type hydraulic actuator)
BI Urging force imparting means
CC Crank chamber
LV Variable stroke link mechanism
HU Housing
L-L Cylinder axis
V-V Vertical axis

### BEST MODE FOR CARRYING OUT THE INVENTION

### Embodiment 1

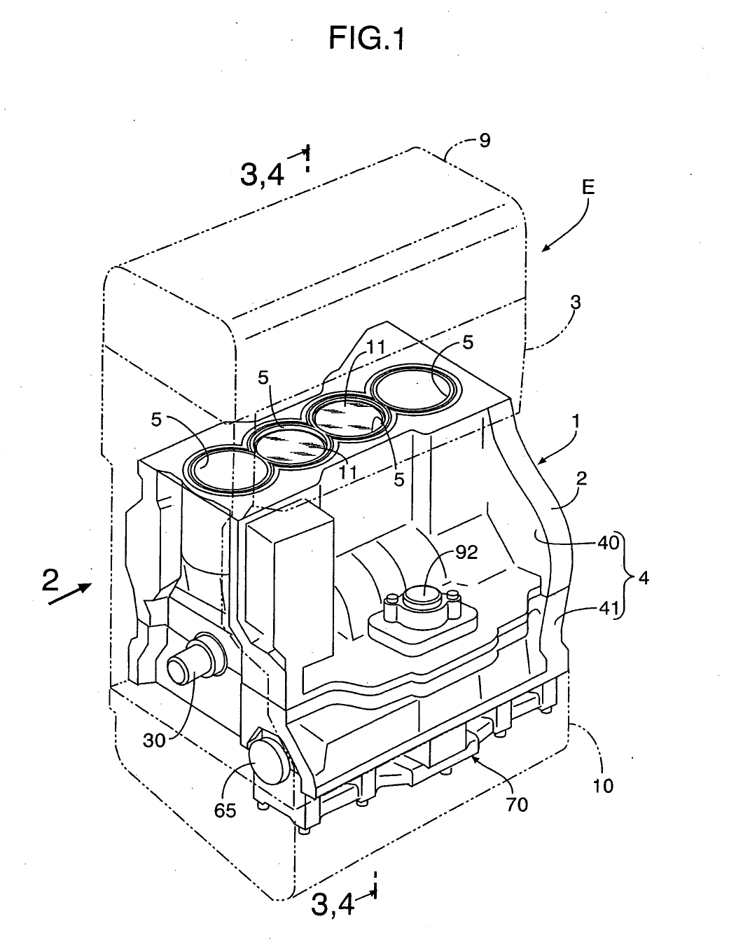

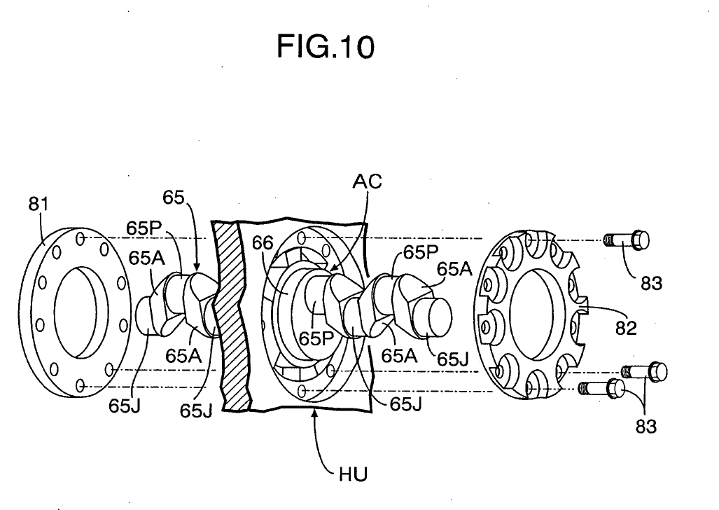

Referring to FIGS. 1 to 11, a first embodiment of the present invention is now explained.

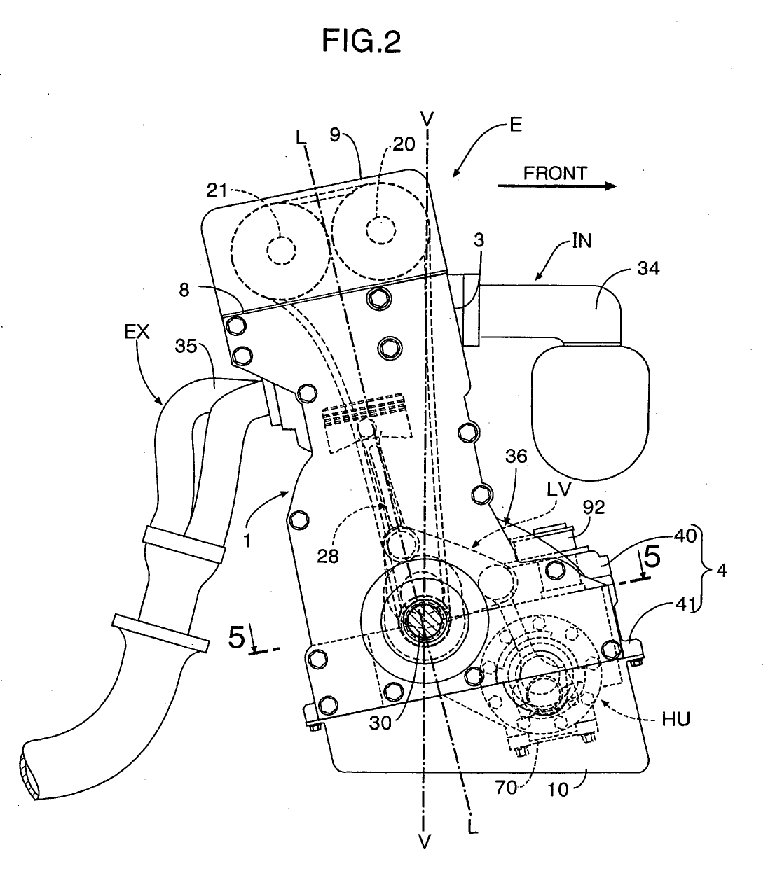

In FIGS. 1 to 4, a variable stroke characteristic engine E related to the present invention is for automobile use and is transversely mounted within an engine compartment of an automobile, which is not illustrated, (a crankshaft 30 of the engine is disposed transversely relative to the direction of travel of the automobile). When this engine E is mounted on an automobile, as shown in FIG. 2, it is in a slightly rearwardly tilted state, that is, in a state in which a cylinder axis L-L is inclined slightly rearward relative to a vertical line V-V.

Furthermore, this variable stroke characteristic engine E is an in-line four-cylinder OHC type four-cycle engine; an engine main body 1 thereof includes a cylinder block 2 in which four cylinders 5 are provided in parallel in the transverse direction, a cylinder head 3 integrally joined to the top of a deck surface of the cylinder block 2 via a gasket 6, an upper block 40 (upper crankcase) integrally formed on a lower part of the cylinder block 2, and a lower block 41 (lower crankcase) integrally joined to a lower face of the upper block 40, the upper block 40 and the lower block 41 forming a crankcase 4. A head cover 9 integrally covers an upper face of the cylinder head 3 via a seal 8, and an oil pan 10 is integrally joined to a lower face of the lower block 41 (lower crankcase).

A piston 11 is slidably fitted into each of the four cylinders 5 of the cylinder block 2, four combustion chambers 12, and intake ports 14 and exhaust ports 15 communicating with these combustion chambers 12 are formed in a lower face of the cylinder head 3 that faces the top faces of these pistons 11, and an intake valve 16 and an exhaust valve 17 are provided in the intake port 14 and the exhaust port 15 respectively so as to open and close them. Furthermore, a valve operating mechanism 18 for opening and closing the intake valve 16 and the exhaust valve 17 is provided on the cylinder head 3. This valve operating mechanism 18 includes an intake side camshaft 20 and an exhaust side camshaft 21 rotatably supported on the cylinder head 3, and intake side and exhaust side rocker arms 24 and 25 that are axially and swingably supported on intake side and exhaust side rocker shafts 22 and 23 provided on the cylinder head 3 and that provide a connection between the intake side and exhaust side camshafts 20 and 21 and the intake valve 16 and exhaust valve 17, and in response to rotation of the intake side and exhaust side camshafts 20 and 21 the intake side and exhaust side rocker arms 24 and 25 swing against valve-closing forces of valve springs 26 and 27, thus opening and closing the intake valve 16 and the exhaust valve 17 with a predetermined timing.

As shown in FIG. 2, the intake side and exhaust side camshafts 20 and 21 are operable in association with a crankshaft 30, which will be described later, via a conventionally known timing transmission mechanism 28, and in response to rotation of the crankshaft 30 they are driven at a rotational speed of ½ of the rotation. The valve operating mechanism 18 is covered by the head cover 9 integrally capping the cylinder head 3. Moreover, the cylinder head 3 is provided with cylindrical plug insertion tubes 31 corresponding to the four cylinders, and a spark plug 32 is inserted into the plug insertion tube 31.

The plurality of intake ports 14 corresponding to the four cylinders 5 open on a front face of the engine main body 1, that is, toward the front side of a vehicle, and an intake manifold 34 of an intake system IN is connected thereto. Since this intake system IN has a conventionally known structure, detailed explanation thereof is omitted.

Furthermore, the plurality of exhaust ports 15 corresponding to the four cylinders 5 open on a rear face of the engine main body 1, that is, toward the rear side of the vehicle, and an exhaust manifold 35 of an exhaust system EX is connected thereto. Since this exhaust system EX has a conventionally known structure, detailed explanation thereof is omitted.

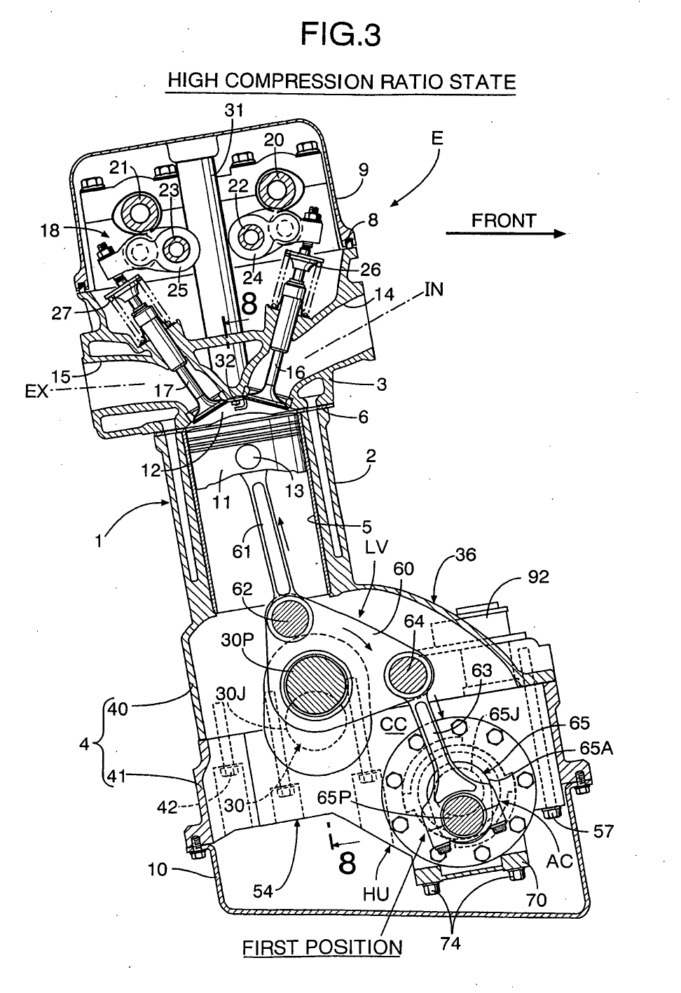

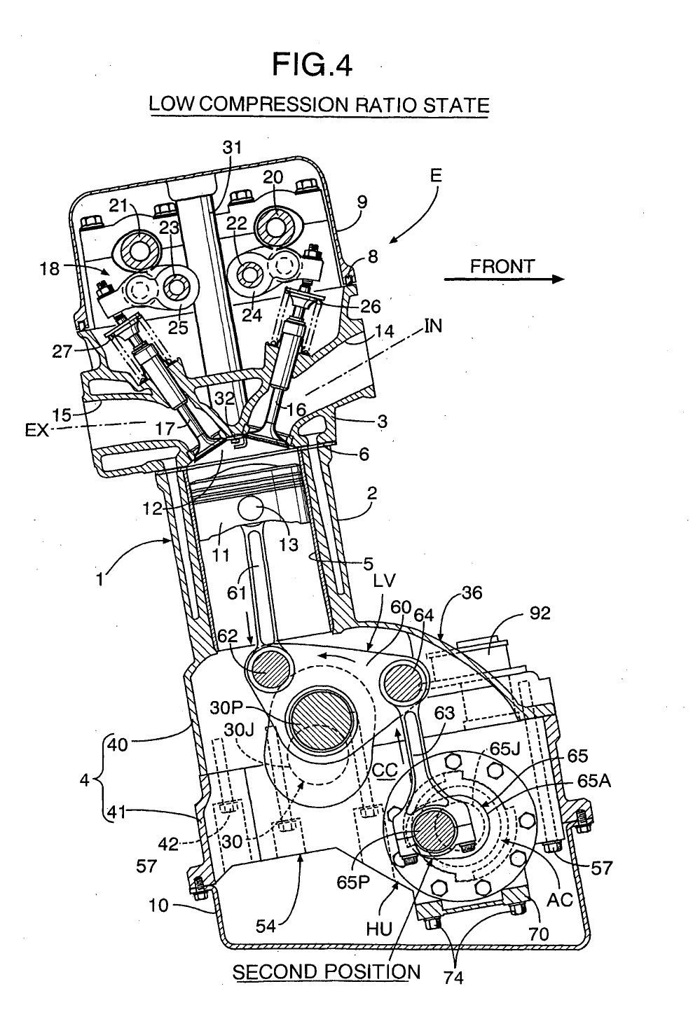

As shown in FIGS. 3 and 4, the crankcase 4, which is formed from the upper block 40 (upper crankcase) on the lower part of the cylinder block 2 and the lower block 41 (lower crankcase), protrudes toward the front (front of the vehicle) relative to the cylinder 5 portion of the cylinder block 2, and a variable stroke link mechanism LV (described later) that makes the stroke travel of the piston 11 variable and a hydraulic actuator AC (described later) driving the variable stroke link mechanism LV are provided within a crank chamber CC of this protruding portion 36.

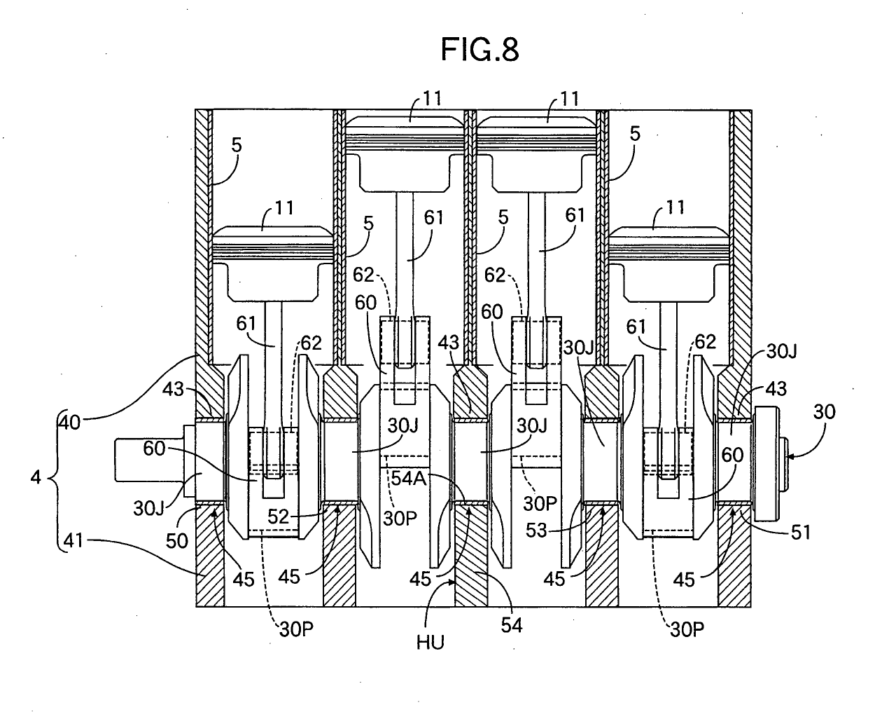

As shown in FIGS. 2 and 3 and FIGS. 5 and 6A (6B), the lower block 41 is fixed via a plurality of linking bolts 42 to the lower face of the upper block 40, which is integrally formed on a lower part of the cylinder block 2. Journal shafts 30J of the crankshaft 30 are rotatably supported on a plurality of journal bearings 43 formed between mating surfaces of the upper block 40 and the lower block 41 (see FIG. 8).

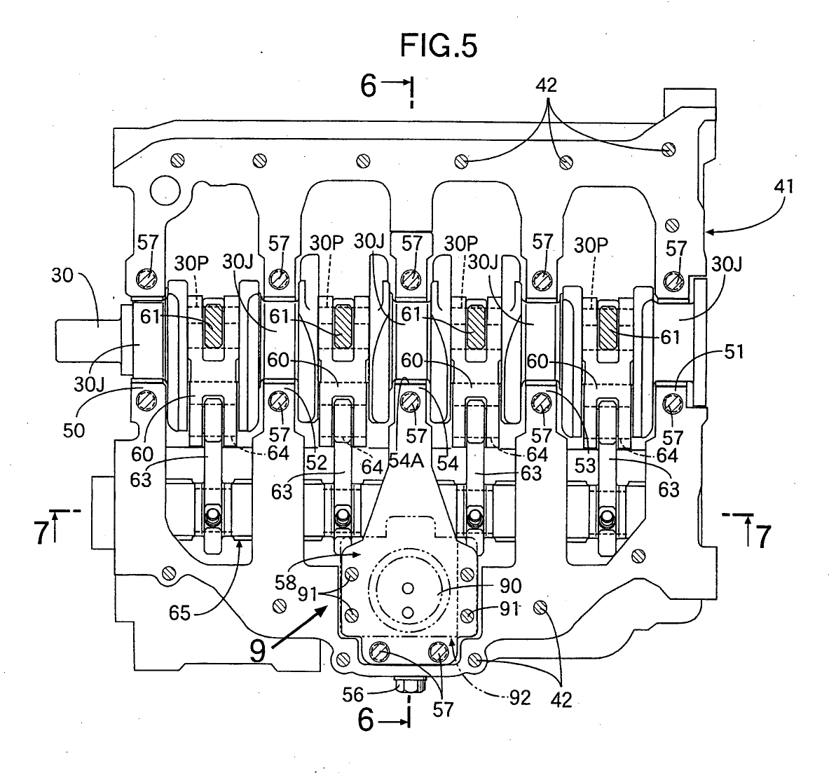

As shown in FIG. 5, the lower block 41 is cast-molded in a structure having a rectangular closed section in plan view; left and right end sections thereof are provided with end section bearing members 50 and 51, a middle section thereof is provided with left and right middle section bearing members 52 and 53, and the center thereof is provided with, as a bearing cap, a center bearing member 54 (a housing HU, described later, is integrally molded therewith), and the journal shafts 30J of the crankshaft 30 are supported by these bearing members 50 to 54.

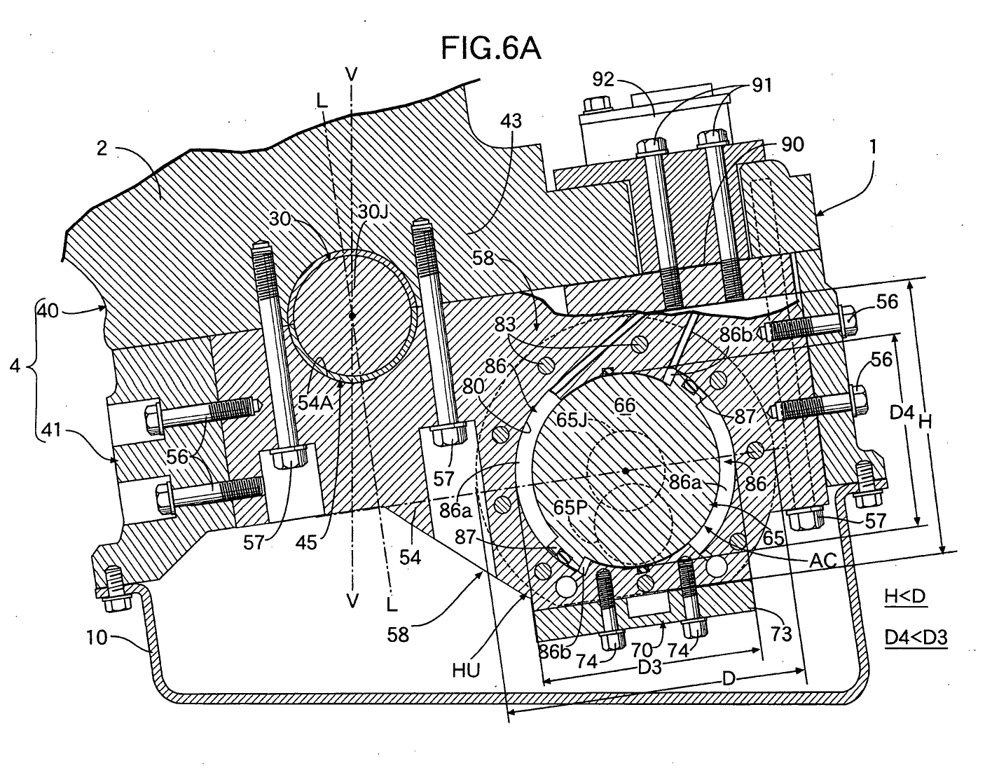

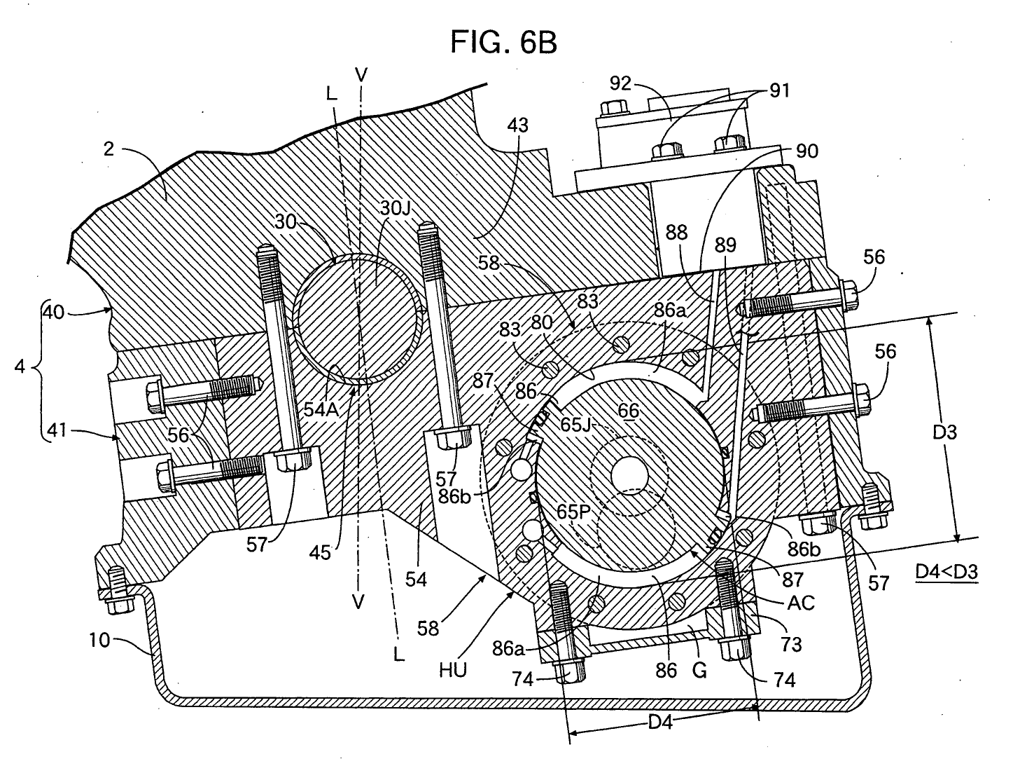

As shown in FIGS. 5, 6A (6B), and 9, the center bearing member 54 as the bearing cap is cast-molded separately from the lower block 41. This center bearing member 54 is fixed firmly to the lower block 41 forming the crankcase 4 via a plurality of transverse securing members, that is, transverse securing bolts 56, from a direction perpendicular to the cylinder axis L-L. Among the plurality of transverse securing members 56, some thereof are positioned between a vertical pair of vane oil chambers 86 provided in the housing HU of the vane type actuator AC, which will be described later. Furthermore, this center bearing member 54 is also fixed firmly to the lower face of the upper block 40 via other securing bolts 57.

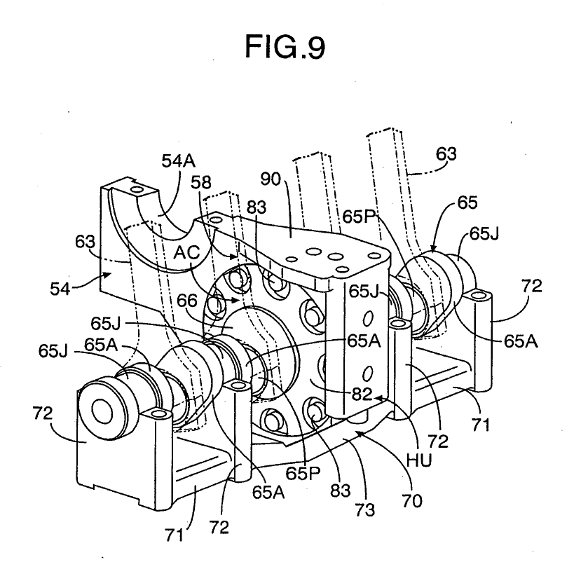

As shown in FIG. 9, one side of the center bearing member 54 as the bearing cap, biased toward one side (the front of the engine main body 1) from a bearing portion 54A for the crankshaft 30, is formed as an expanded portion 58 having an extended vertical width and a large thickness, and the housing HU of the vane type actuator AC, which will be described later, is formed in this expanded portion 58.

Referring mainly to FIGS. 3 and 4, the structure of the variable stroke link mechanism LV, which makes the stroke travel of the piston 11 variable, is now explained. A middle section of a triangular lower link 60 is swingably and pivotably supported on and linked to each of a plurality of crankpins 30P of the crankshaft 30, which is rotatably supported on the crankcase 4, that is, mating surfaces of the upper block 40 and the lower block 41. Pivotably supported on and linked to one end (upper end) of the lower link 60 is a lower end (big end) of an upper link (connecting rod) 61 pivotably supported on and linked to a piston pin 13 of the piston 11 via a first linking pin 62, and pivotably supported on and linked to the other end (lower end) of each lower link 60 via a second linking pin 64 is an upper end of a control link 63. This control link 63 extends downwardly, and an eccentric pin 65P of a control shaft 65 (described in detail later), which is formed in a crank shape, is pivotably supported on and linked to a lower end of the control link 63. The control shaft 65 is driven within a predetermined angular range (about 90 degrees) by the hydraulic actuator AC (described in detail later), and this causes the eccentric pin 65P to be displaced, thus swinging the control link 63. Specifically, the control shaft 65 can rotate between a first position (eccentric pin 65P at a lower position) shown in FIG. 3 and a second position (eccentric pin 65P at a leftward position) shown in FIG. 4. In the first position shown in FIG. 3, since the eccentric pin 65P of the control shaft 65 is in the lower position, the control link 63 is pulled down, the lower link 60 swings in a clockwise direction around the crankpin 30P of the crankshaft 30, the upper link 61 is pushed upward, the position of the piston 11 attains a high position relative to the cylinder 5, and the engine E attains a high compression ratio state. Conversely, in the second position shown in FIG. 4, since the eccentric pin 65P of the control shaft 65 is positioned leftward (at a higher position than the first position), the control link 63 is pushed upward, the lower link 60 swings in an anticlockwise direction around the crankpin 30P of the crankshaft 30, the upper link 61 is pushed down, the position of the piston 11 attains a less high position relative to the cylinder 5, and the engine E attains a low compression ratio state. As described above, by controlling pivoting of the control shaft 65, the control link 63 swings, conditions for the restriction of movement of the lower link 60 change, the stroke characteristics, such as the position of top dead center of the piston 11 change, and the compression ratio of the engine E can thereby be freely controlled.

The upper link 61, the first linking pin 62, the lower link 60, the second linking pin 64, and the control link 63 form the variable stroke link mechanism LV related to the present invention.

As shown in FIGS. 6A (6B), 7, 9, and 10, the control shaft 65, which is linked to the control link 63 and operates the variable stroke link mechanism LV, is formed, in the same way as the crankshaft 30, in a crank shape, in which a plurality of journal shafts 65J and the eccentric pins 65P are alternately joined via arms 65A, and a cylindrical vane shaft 66 of the vane type hydraulic actuator AC is coaxially provided integrally with a section between the axially central eccentric pins 65P. The eccentric pins 65P of the control shaft 65 are directly fixed to eccentric positions on each of opposite side faces of the vane shaft 66. The control shaft 65 is biased toward one side of the lower block 41 (the front side of the engine main body 1), and the journal shafts 65J thereof are rotatably supported between the lower block 41 and a bearing block 70 fixed to the lower face thereof by a plurality of linking bolts 68.

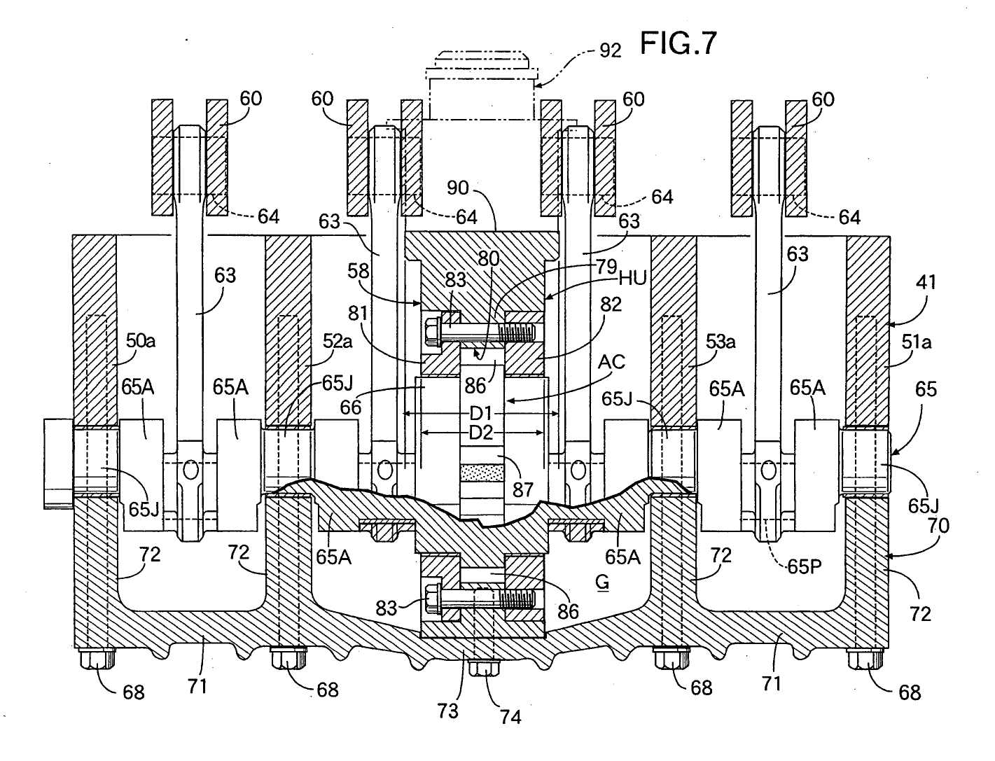

As shown in FIGS. 6A (6B), 7, and 9, the bearing block 70 supporting the control shaft 65 is cast-molded in a block shape with a linking member 71 extending in the axial direction of the control shaft 65, a plurality of bearing walls 72 joined integrally to and rising from the linking member 71 while being spaced in the longitudinal direction thereof, and a housing receiving part 73 provided in a longitudinally central part of the linking member 71, thereby guaranteeing high rigidity, and as described above the plurality of journal shafts 65J of the control shaft 65 are rotatably supported by bearings formed on mating surfaces of an upper face of the plurality of bearing walls 72 and a lower face of bearing walls 50a, 51a, 52a, and 53a extended by the bearing members 50, 51, 52, and 53 of the lower block 40. Furthermore, as shown in FIG. 7, the housing receiving part 73, which is formed in the bearing block 70, is formed in a downwardly concave shape in a direction away from the housing HU, a recess G is formed thereabove, a lower part of the housing HU of the vane type hydraulic actuator AC is housed in the recess G, and the lower part of the housing HU is secured onto the housing receiving part 73 via securing members, that is, a plurality of securing bolts 74. Therefore, the housing HU of the hydraulic actuator AC is integrally secured to and supported on the bearing block 70 supporting the control shaft 65.

Since the housing HU of the actuator AC is integrally secured to the bearing block 70, which has high rigidity, the rigidity of the housing HU itself is increased and, furthermore, since the recess G is formed in the housing receiving part 73 of the bearing block 70, and the lower part of the housing HU is housed in this recess G as a housing space, the actuator AC can be mounted compactly on the engine main body 1 with high rigidity, thereby contributing to a reduction in the dimensions of the engine E itself.

As is most clearly shown in FIG. 9, one side of the center bearing member 54 as the bearing cap, biased toward one side (the front of the engine main body 1) from the bearing portion 54A for the crankshaft 30, is formed as the expanded portion 58 having an extended vertical width and a large thickness, and the housing HU of the vane type hydraulic actuator AC, which will be described in detail later, is formed in this expanded portion 58.

As shown in FIGS. 6A (6B), 7, 9, and 10, the vane type hydraulic actuator AC provided coaxially with the control shaft 65 is provided within the crank chamber CC of the engine main body 1 beneath the crankshaft 30, and the housing HU is provided in the expanded portion 58 on one side of the center bearing member 54 (fixed integrally to the upper block 40 and the lower block 41) as the bearing cap. A short cylindrical vane chamber 80 with opposite end faces opened is formed in an axially central part of the housing HU. The vane shaft 66, which is integral with the control shaft 65, is housed within this vane chamber 80, and a pair of vanes 87 are projectingly provided integrally with an axially central part on the outer periphery of the vane shaft 66 with a phase difference of about 180°. Furthermore, axially left and right opposite side parts (having a slightly smaller diameter than that of the central part) of the vane shaft 66 are rotatably supported, via surface bearings, on annular left and right cover members 81 and 82 (left and right vane bearings) that are fixed, via a plurality of securing members, that is, securing bolts 83, to opposite apertures of the housing HU in the outer peripheral part of the vane chamber 80. The opened side faces of the housing HU are closed by the left and right cover members 81 and 82, and these left and right cover members 81 and 82 form part of the housing.

Between an inner peripheral face of a vane case 79 and the vane shaft 66, the pair of vanes 87 projectingly provided integrally with the outer peripheral face of the vane shaft 66 are housed within a pair of fan-shaped vane oil chambers 86 defined with a phase difference of about 180°, each vane 87 oil-tightly divides the interior of the fan-shaped vane oil chamber 86 into two control oil chambers, and controlling the supply and discharge of hydraulic oil from a hydraulic circuit (described later) to these two control oil chambers enables the vane shaft 66 to be made to reciprocate through a predetermined angular range together with the control shaft 65.

As described above, the housing HU of the hydraulic actuator AC, which drives the control shaft 65, can be made compact and formed with a small number of components using the center bearing member of the lower block 41 (which is formed separately from the lower block 41 and is fixed thereto), and the volume of the housing HU occupying the interior of the crank chamber CC can be made small, thus suppressing any increase in the bulk of the crankcase.

As shown in FIGS. 6A (6B) and 7, the plurality of securing members 83 are provided along the axial direction of the crankshaft 30 to thus form crankshaft-direction securing members, and some of these securing members 83 are provided so as to cross between the transverse securing members 56.

As shown in FIG. 6A, the pair of vane oil chambers 86 are arranged in a direction perpendicular to the cylinder axis L-L of the engine main body 1 with the vane shaft 66 interposed therebetween within the housing HU beneath the crankshaft 30, and a height H of the housing HU is thereby made substantially less than a lateral width D. The lower part of the housing HU is secured to the housing receiving part 73 of the bearing block 70 between the pair of vane oil chambers 86 via securing members, that is, the plurality of securing bolts 74, and since these securing bolts 74 avoid the vane oil chamber 86, the vertical width between the housing HU and the housing receiving part 73 can be reduced, and they can be secured by the securing bolts 74. Therefore, the vane type hydraulic actuator AC can be supported on the engine main body 1 while reducing the height H compared with its lateral width D and, moreover, the housing HU can be secured firmly to the housing receiving part 73 while reducing the vertical width from the housing receiving part 73.

The housing HU of the vane type hydraulic actuator AC driving the control shaft 65 can be made compact and formed with a small number of components using the center bearing member of the lower block 41 as the bearing cap (formed separately from the lower block 41 and fixed thereto), and the volume of the housing HU occupying the interior of the crank chamber CC can be made small, thus suppressing any increase in the bulk of the crankcase.

As shown in FIG. 6B (modified example), the pair of vane oil chambers 86 may be arranged in the vertical direction, that is, the cylinder axis L-L direction, with the vane shaft 66 interposed therebetween, and the vane chamber 80, which is formed in the housing HU, of the actuator AC is formed so as to have a width D4 in the transverse direction (direction perpendicular to the cylinder axis L-L) that is smaller than a width D3 in the vertical direction.

As shown in FIGS. 5, 7, and 9, a flat mounting face 90 is formed so as to widen in a dovetail shape from the bearing 54A for the crankshaft 30 toward an end part of the housing HU side on an upper face of the housing HU formed in the center bearing member 54, and as shown in FIG. 7, a width D1 in the control shaft 65 direction of the mounting face 90 is made wider than a width D2 of the housing HU, a valve unit 92 of the hydraulic control circuit of the hydraulic actuator AC is fixedly supported on the mounting face 90 via a plurality of bolts 91, and this valve unit 92 is disposed so as to run through a wall face of the cylinder block 2 and be exposed on an upper face thereof (see FIG. 1). The valve unit 92 can thereby be fixed firmly to the mounting face of the housing HU, and since the valve unit 92 is open to four sides on the mounting wall face of the cylinder block 2, it becomes easy to carry out switching operations for the hydraulic actuator AC, maintenance, etc.

As shown in FIGS. 6B and 7, the pair of vanes 87 projectingly provided integrally with the outer periphery of the vane shaft 66 are each housed within the pair of vane oil chambers 86, the outer periphery of the vanes 87 is in sliding contact with the inner periphery of the vane oil chamber 86 via a packing, and each vane 87 oil-tightly divides the interior of the fan-shaped vane oil chamber 86 into two control oil chambers 86a and 86b. Hydraulic oil paths 88 and 89 communicating with the control oil chambers 86a and 86b are bored in the housing HU at positions displaced in the crankshaft 30 direction relative to the transverse securing members 56, and these hydraulic passages 88 and 89 are connected to a solenoid valve V within the valve unit 92, which will be described later. These hydraulic passages 88 and 89 are allowed to overlap the transverse securing members 56 when viewed in the crankshaft 30 direction. Furthermore, providing the hydraulic passages 88 and 89 at positions on the inner side of the crankcase 4, that is, closer to the crankshaft 30, enables any increase in the dimensions in the width direction of the engine E to be suppressed.

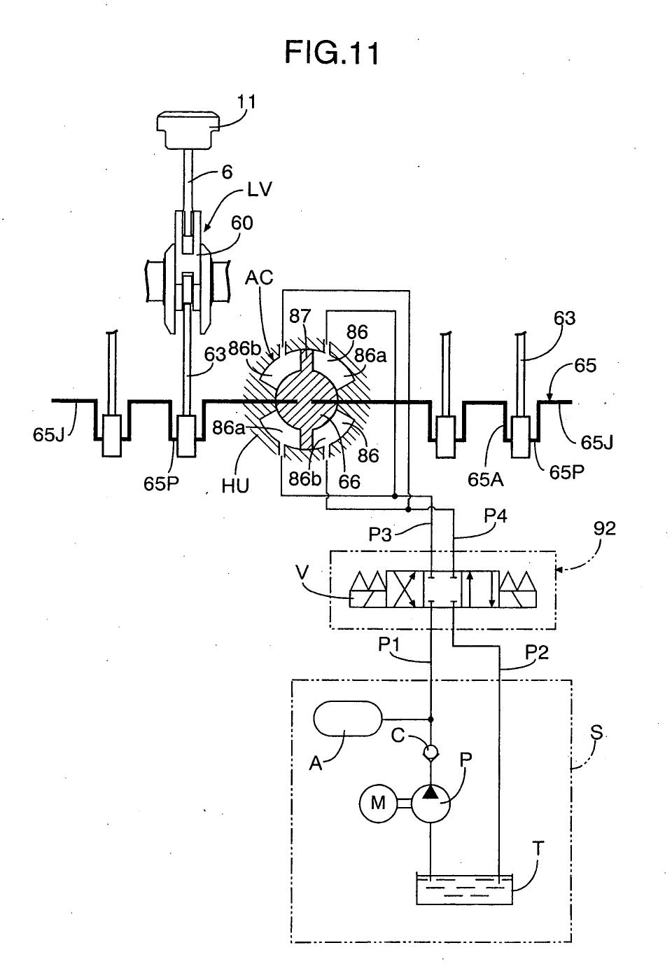

The hydraulic circuit of the vane type hydraulic actuator AC for driving and controlling the variable stroke link mechanism LV is now explained by reference to FIG. 11.

As described above, the interior of the pair of fan-shaped vane oil chambers 86 formed in the vertical direction by the vane shaft 66 of the control shaft 65 and the housing HU is divided into the two control oil chambers 86a and 86b by the vane 87, and these control oil chambers 86a and 86b are connected to an oil tank T via the hydraulic circuit, which is described below. Connected to the hydraulic circuit are an oil pump P driven by a motor M, a check valve C, an accumulator A, and the solenoid switching valve V. The oil tank T, the motor M, the oil pump P, the check valve C, and the accumulator A form a hydraulic supply system S, and are provided at an appropriate location on the engine main body 1, and the solenoid switching valve V is provided in the interior of the valve unit 92. The hydraulic supply system S and the solenoid switching valve V are connected by two pipelines P1 and P2, and the solenoid switching valve V and the control oil chambers 86a and 86b of the vane type hydraulic actuator AC are connected by the hydraulic passages 88 and 89 formed in the housing HU (see FIG. 6B).

Therefore, in FIG. 11, when the solenoid switching valve V is switched to a right position, hydraulic oil generated by the oil pump P is supplied to the control oil chamber 86a, the oil pressure pushes the vane 87, and the control shaft 65 rotates in an anticlockwise direction, whereas when the solenoid switching valve V is switched to a left position, the hydraulic oil generated by the oil pump P is supplied to the control oil chamber 86b, the oil pressure pushes the vane 87, and the control shaft 65 rotates in a clockwise direction; by so doing, the phase of the eccentric pin 65P of the control shaft 65 changes. As described above, the control link 63 of the variable stroke link mechanism LV is swingably and pivotably supported on and linked to the eccentric pin 65P of the control shaft 65, and by driving the control shaft 65 (through about)90°, the variable stroke link mechanism LV is operated by the change in phase of the eccentric pin 65P of the control shaft 65.

Since the hydraulic actuator AC for driving the control shaft 65 is provided in a central part of the control shaft 65, and is formed from the housing HU provided in the center bearing member 54, the cover members 81 and 82 covering the apertures of the housing HU, the vane case 79 formed integrally with the inner periphery of the housing HU, and the vane shaft 66 provided integrally with the control shaft 65, the number of components of the hydraulic actuator AC can be decreased, a reduction in the weight and dimensions thereof can be achieved and, moreover, the efficiency of assembly of the hydraulic actuator improves.

Furthermore, as shown in FIG. 6B (modified example), when the pair of vane oil chambers 86 are arranged in the cylinder axis L-L direction of the engine main body 1, the transverse width D4 of the actuator AC is substantially reduced compared with the width D3 in the vertical direction, the width of the engine E in the transverse direction perpendicular to the crankshaft 30 is thus reduced, and any increase in the dimensions in this direction is suppressed.

Moreover, if auxiliary engine equipment (not illustrated) is provided on the exterior of the crankcase 4 having the actuator AC provided therein, it is easy to dispose the auxiliary engine equipment above the engine E, which is inclined to one side (rear side), on the other side (front side) of the engine and, moreover, since the pair of vane oil chambers 86 of the actuator AC are arranged in the axial direction of the cylinder 5, the auxiliary engine equipment can be disposed in the proximity of the actuator AC.

Furthermore, as shown in FIG. 6A, if the pair of vane oil chambers 86 are arranged in a direction perpendicular to the cylinder axis L-L of the engine main body 1, the height of the housing for the actuator is reduced, thereby enabling any increase in the dimensions of the engine in the height direction to be suppressed.

Moreover, as shown in FIG. 6A, if the housing HU of the vane type hydraulic actuator AC is secured to the housing receiving part 73 by the securing members 74 between the pair of vane oil chambers 86, which are arranged in a direction perpendicular to the cylinder axis L-L, the height of the support part of the housing HU can also be reduced, thereby enabling any increase in the dimensions of the engine E in the height direction to be still further suppressed.

Furthermore, it is also possible to suppress any increase in the dimensions of the engine main body in the height direction and guarantee the degree of freedom for the range of inclination of the engine.

### Embodiment 2

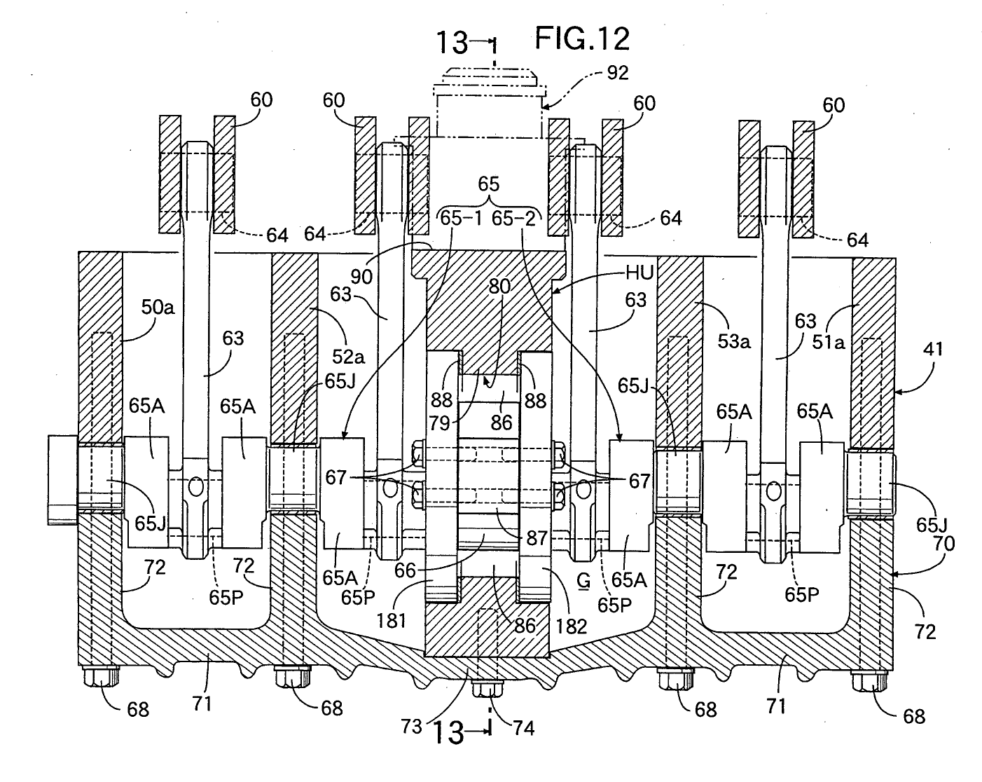

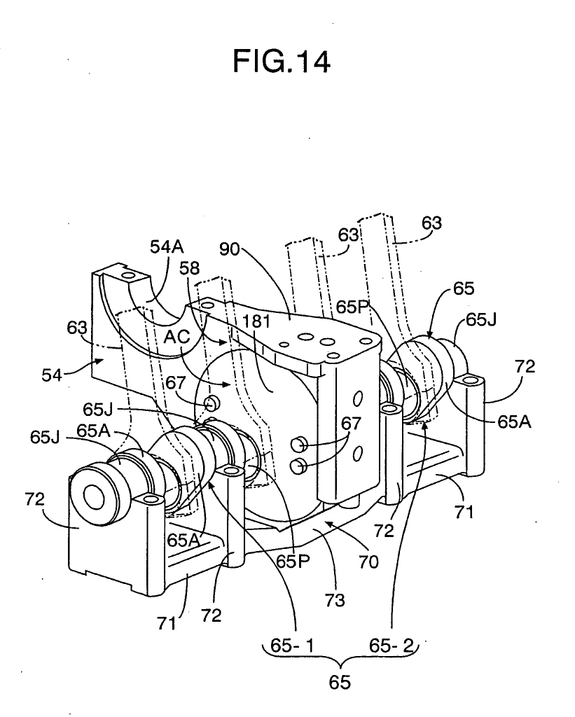

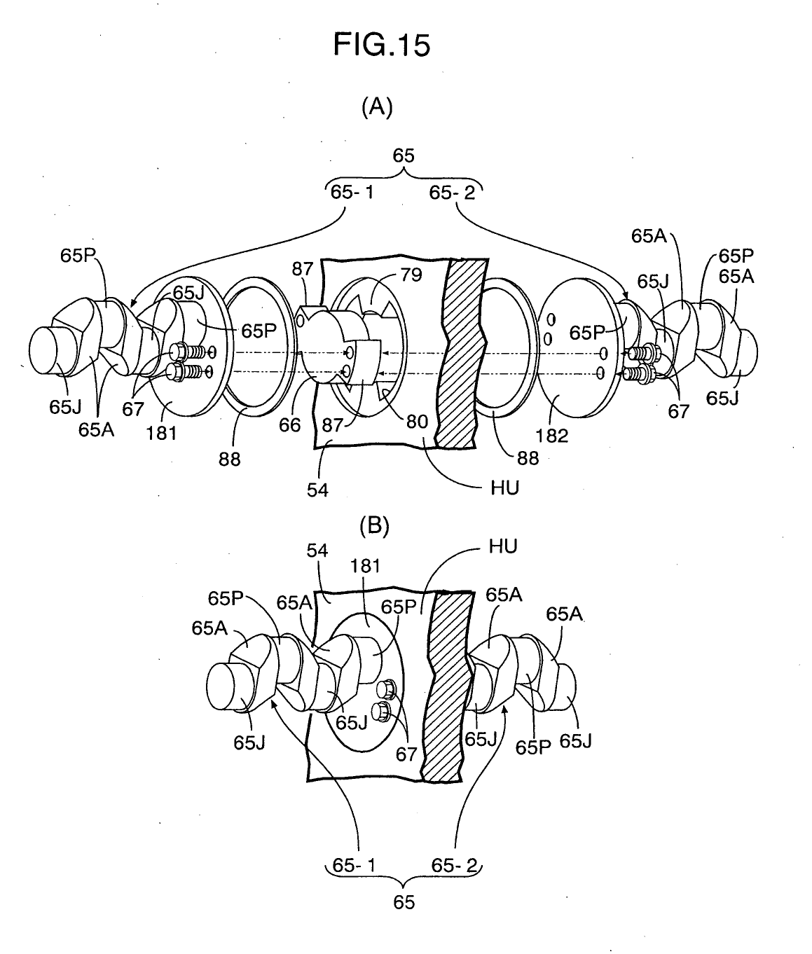

A second embodiment of the present invention is now explained by reference to FIGS. 12 to 15.

In FIGS. 12 to 15, a control shaft 65 that a hydraulic actuator AC is provided with is divided from a longitudinally central part thereof into a first control shaft 65-1 and a second control shaft 65-2, a pair of disc-shaped cover members 181 and 182 of the hydraulic actuator AC are concentrically joined integrally to connecting end faces of the first and second control shafts 65-1 and 65-2 (end faces of eccentric pins 65P), and a vane shaft 66 having a pair of vanes 87 provided thereon is fixed to a central part of inner faces of these cover members 181 and 182 by securing members, that is, a plurality of bolts 67, thereby integrating the first and second control shafts 65-1 and 65-2, the cover members 181 and 182, and the vane shaft 66. In this case, the bolts 67 secure the first and second control shafts 65-1 and 65-2, the cover members 181 and 182, and the vane shaft 66 at positions where the bolts 67 do not overlap the eccentric pins 65P of the control shaft 65, and the securing positions can be made as close to the shaft center of the control shaft 65 as possible.

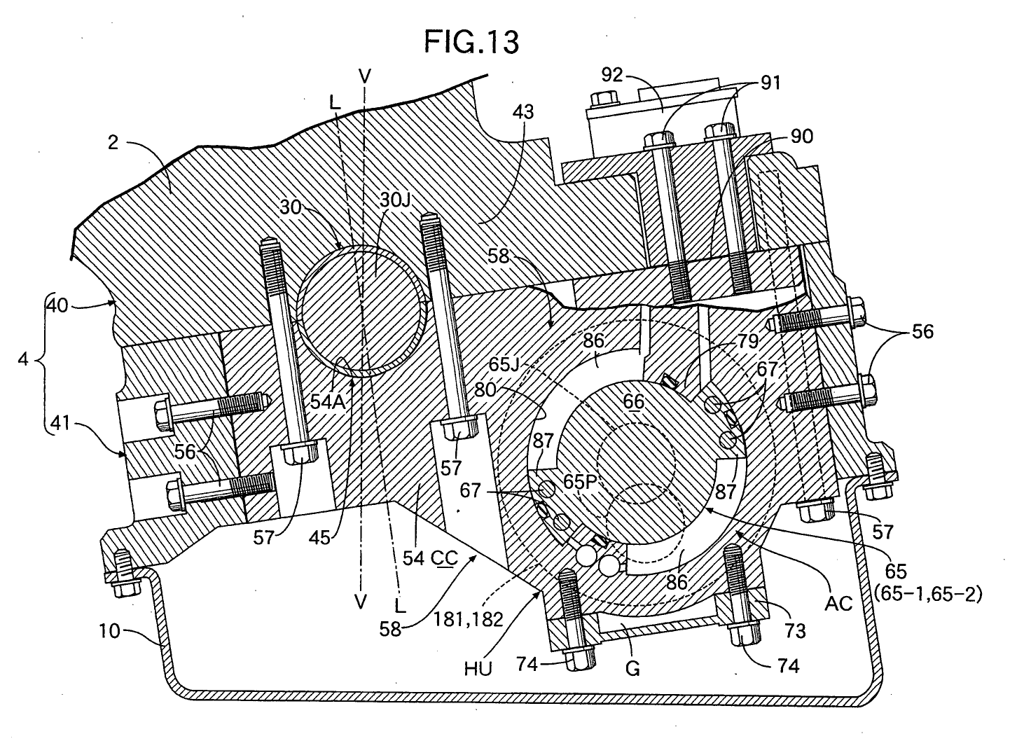

As shown in FIGS. 12 and 13, the control shaft 65 runs through a housing HU, the vane shaft 66 is housed within a vane case 79, a pair of vane oil chambers 86 are formed therebetween, and a vane 87 divides the interior of the vane oil chamber 86 into two control oil chambers in the same manner as in the first embodiment. The cover members 181 and 182 are rotatably and bearingly supported on opposite sides within the housing HU via a packing 88. The packing 88 is provided radially outside the vane 87 and between the housing HU of the actuator AC and the cover members 181 and 182.

Since the cover members 181 and 182 are bearingly supported on the housing HU, it is possible to stably support the actuator AC on the housing HU.

In the same manner as in the first embodiment, controlling the supply of hydraulic oil from a hydraulic pump P of a hydraulic circuit to the vane oil chambers 86 enables the hydraulic actuator AC to reciprocatingly pivot through a predetermined angle, thus operating a variable stroke link mechanism LV.

In accordance with this second embodiment, since the cover members 181 and 182 and the vane shaft 66 are formed integrally with the central part of the control shaft 65, the hydraulic actuator AC can be formed with a smaller number of components so as to be small and lightweight, the space occupied within a crank chamber CC can be reduced, the degrees of freedom in mounting can be increased and, moreover, the ease of assembly is good.

### Embodiment 3

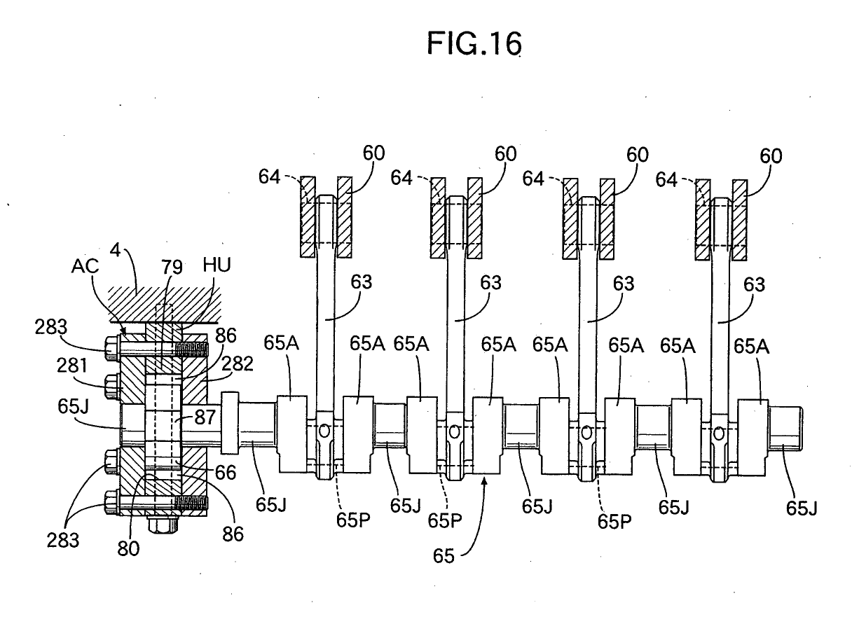

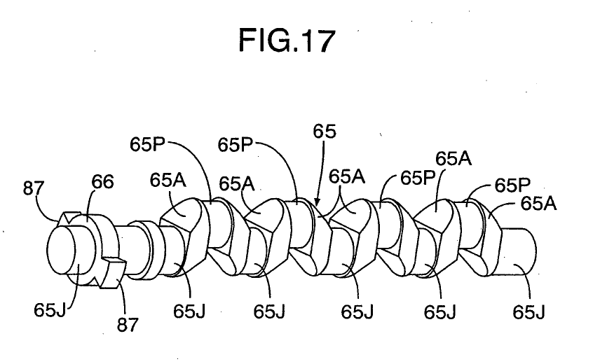

A third embodiment of the present invention is now explained by reference to FIGS. 16 and 17.

This third embodiment is a case in which a hydraulic actuator AC is provided on an end part of a control shaft 65. A vane shaft 66 having a pair of vanes 87 provided thereon is formed integrally with a journal shaft 65J in an end part of the control shaft 65. The hydraulic actuator AC, which drives the control shaft 65, is provided in the end part of the control shaft 65. A housing HU of this hydraulic actuator AC is fixedly supported at an appropriate location on an engine main body 1, cover members 281 and 282 are fixed to opposite sides of the housing HU via securing members, that is, a plurality of bolts 283, and the vane shaft 66 on the end part of the control shaft 65 is rotatably supported by these cover members 281 and 282. A vane type hydraulic drive part of the hydraulic actuator AC of the above type is provided within a vane oil chamber 86 defined by the housing HU and the cover members 281 and 282.

Therefore, in accordance with this third embodiment also, since the vane shaft 66 having the vanes 87 of the hydraulic actuator AC is formed integrally with the control shaft 65, the number of components of the hydraulic actuator AC is reduced, a reduction in the dimensions and weight can be achieved, and the ease of assembly therefore improves.

### Embodiment 4

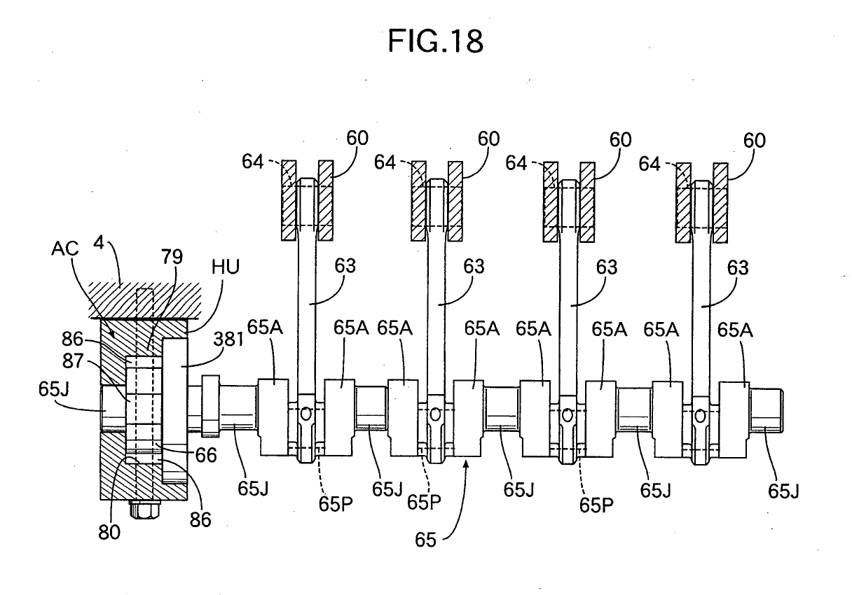

A fourth embodiment of the present invention is now explained by reference to FIG. 18.

This fourth embodiment is also a case in which a hydraulic actuator AC is provided on an end part of a control shaft 65 as in the third embodiment. A vane shaft 66 having a pair of vanes 87 provided thereon and a cover member 381 of the hydraulic actuator AC are formed integrally with a journal shaft 65J on the end part of the control shaft 65. A housing HU of this hydraulic actuator AC is fixedly supported at an appropriate location on an engine main body 1, and the end part of the control shaft 65 having the vane shaft 66 and the cover member 381 formed integrally therewith is assembled to the housing HU. A vane type hydraulic drive part of the hydraulic actuator AC is provided within a vane oil chamber 86 defined by the housing HU and the cover member 381 as in the third embodiment.

In accordance with this fourth embodiment, since the cover member 381 and the vane shaft 66 having the vane 87 of the hydraulic actuator AC formed integrally therewith are formed integrally with the control shaft 65, the number of components of the hydraulic actuator AC is reduced, a reduction in the dimensions and weight can be achieved, and the ease of assembly therefore improves.

### Embodiment 5

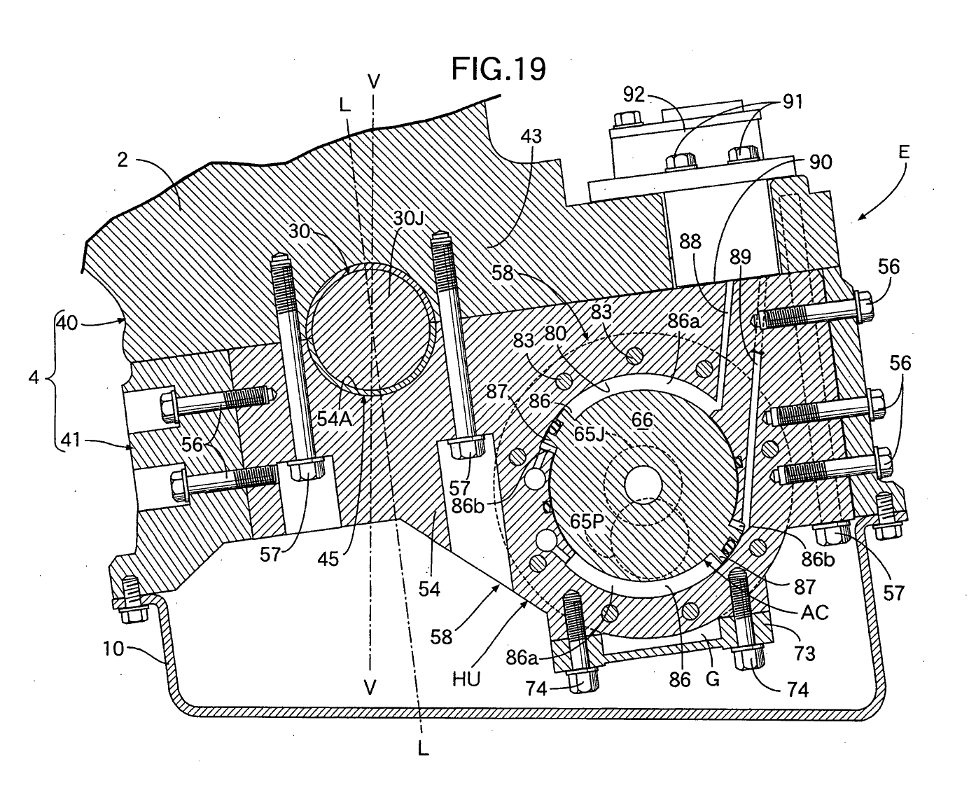

A fifth embodiment of the present invention is explained by reference to FIG. 19.

This fifth embodiment employs a structure for securing, to a lower block 41, a center bearing member 54 as a bearing cap, in which a vane type hydraulic actuator AC is provided. Since, among a plurality of transverse securing members 56 for securing the center bearing member 54 to the lower block 41, two transverse securing members 56 located between a pair of vane oil chambers 86 avoid the vane oil chambers 86, it is possible to use a long securing portion (screwing portion) while maintaining a sufficient thickness from a vane chamber 80, thereby increasing the rigidity with which the center bearing member 54 as the bearing cap, that is, the actuator AC, is secured to the lower block 41 without increasing the transverse width of an engine main body 1.

### Embodiment 6

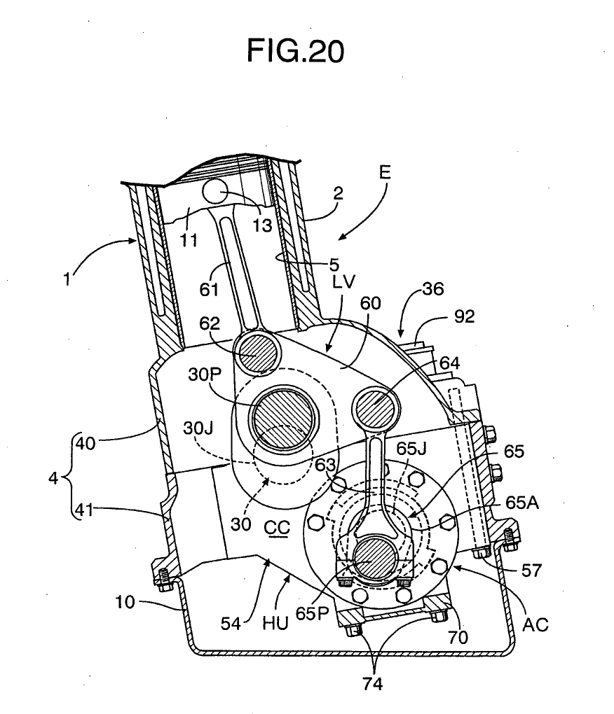

A sixth embodiment of the present invention is now explained by reference to FIG. 20.

In this sixth embodiment, the structure of a variable stroke link mechanism LV is slightly different from that of the first embodiment.

The shaft center of a control shaft 65 of a vane type hydraulic actuator AC is disposed toward a crankshaft 30 side relative to a point at which a lower link 60 and a control link 63 are pivotably supported and linked via a second linking pin 64, that is, on the inward side of a crankcase 4. This further suppresses any increase in the transverse width, perpendicular to the crankshaft 30, of an engine E.

### Embodiment 7

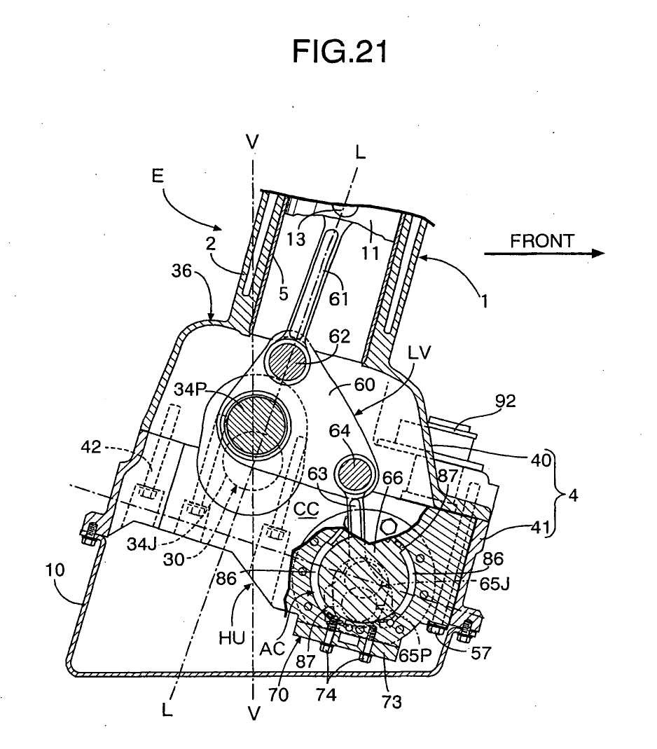

A seventh embodiment of the present invention is now explained by reference to FIG. 21.

In this seventh embodiment, when an engine E is mounted on an automobile, it is disposed in a slightly forwardly tilted attitude, that is, a cylinder axis L-L thereof is slightly forwardly tilted relative to a vertical line V-V. A crankcase 4 of an engine main body 1 protrudes further forward than a cylinder barrel part thereof, a vane type hydraulic actuator AC is housed within a crank chamber CC of the protruding portion, and this actuator AC is supported on the engine main body 1 as in the first embodiment beneath a crankshaft 30; a pair of vane oil chambers 86 formed in a housing HU thereof are arranged in a direction perpendicular to the cylinder axis L-L, and a lower part of the housing HU is secured to a housing receiving 73 of a bearing block 70 between the pair of vane oil chambers 86 via securing members, that is, a plurality of securing bolts 74.

Therefore, in accordance with this seventh embodiment, it is also possible to suppress any increase in the dimensions in the height direction of the engine E, improve the rigidity with which the housing HU is supported and, in addition, reduce the fore-and-aft width of the engine E.

### Embodiment 8

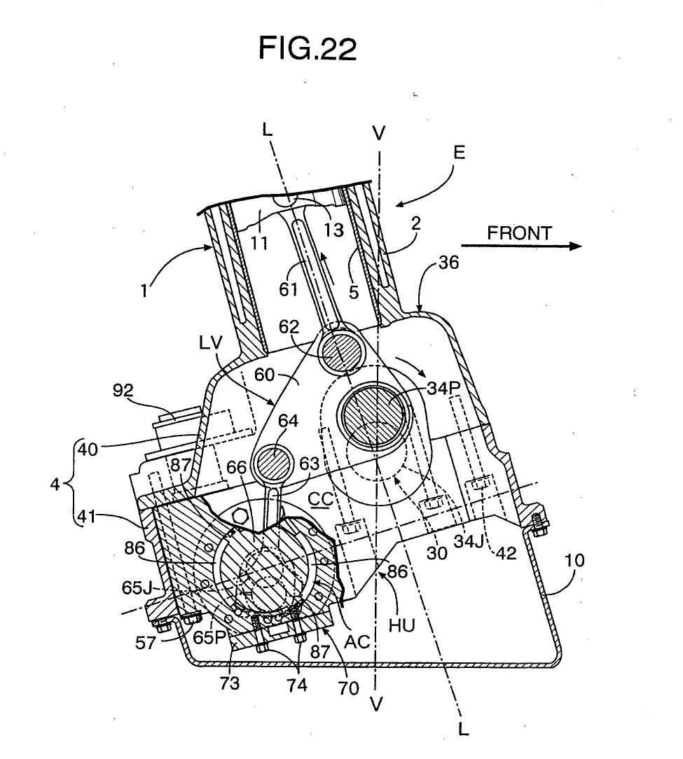

An eighth embodiment of the present invention is now explained by reference to FIG. 22.

In this eighth embodiment, when an engine E is mounted on an automobile, it is disposed in a slightly rearwardly tilted attitude as in the first embodiment, that is, a cylinder axis L-L thereof is slightly rearwardly tilted relative to a vertical line V-V. A crankcase 4 of an engine main body 1 protrudes further rearward than a cylinder barrel part thereof, a vane type hydraulic actuator AC is housed within a crank chamber CC of the protruding portion, and this actuator AC is supported on the engine main body 1 as in the first embodiment beneath a crankshaft 30; a pair of vane oil chambers 86 formed in a housing HU thereof are arranged in a direction perpendicular to the cylinder axis L-L, and a lower part of the housing HU is secured to a housing receiving 73 of a bearing block 70 between the pair of vane oil chambers 86 via securing members, that is, a plurality of securing bolts 74.

Therefore, in accordance with this eighth embodiment also, it is possible to suppress any increase in the dimensions in the height direction of the engine E, improve the rigidity with which the housing HU is supported and, in addition, reduce the fore-and-aft width of the engine E.

### Embodiment 9

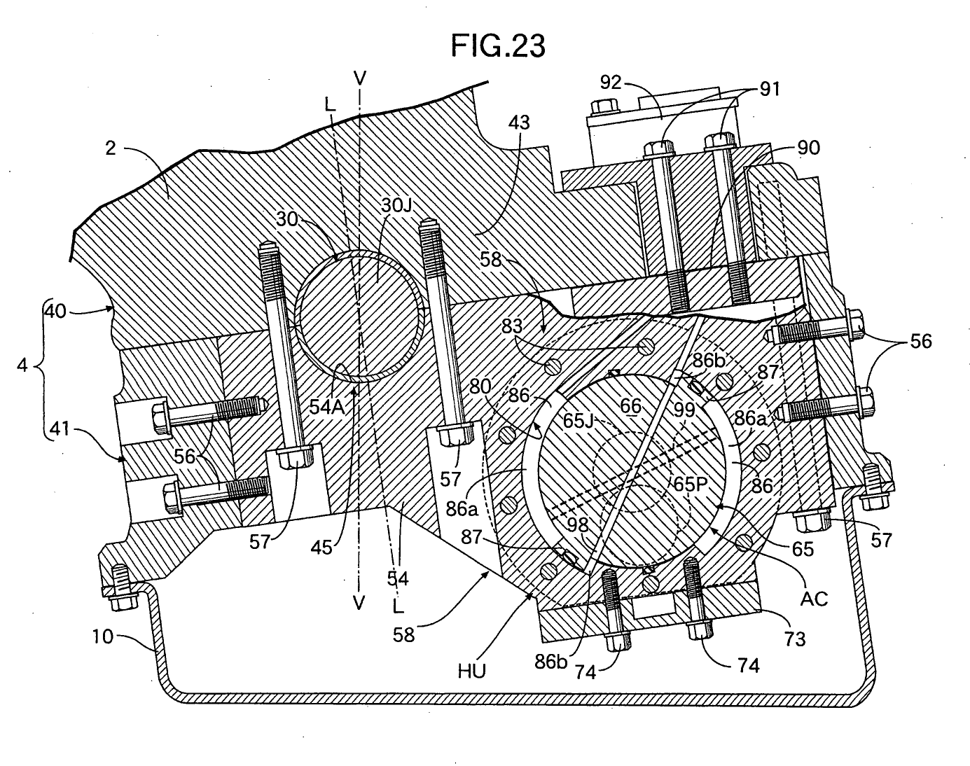

A ninth embodiment of the present invention is now explained by reference to FIG. 23.

In this ninth embodiment, the arrangement of an oil path formed in a vane type hydraulic actuator AC is different from that of the first embodiment, that is, this is a case in which there is no oil path beneath a vane shaft 66, and an oil supply path is formed only in a housing HU above the vane shaft 66; as shown in FIG. 23, two communication oil paths 98 and 99 are bored in the vane shaft 66a in a radially crossed state while being displaced in the axial direction thereof, one communication oil path 98 provides communication between a pair of control oil paths 86b, and the other communication oil path 99 provides communication between a pair of control oil paths 86a. This enables an oil path formed in a lower part of the housing HU to be omitted, thereby further improving the rigidity of the lower part of the housing HU.

### Embodiment 10

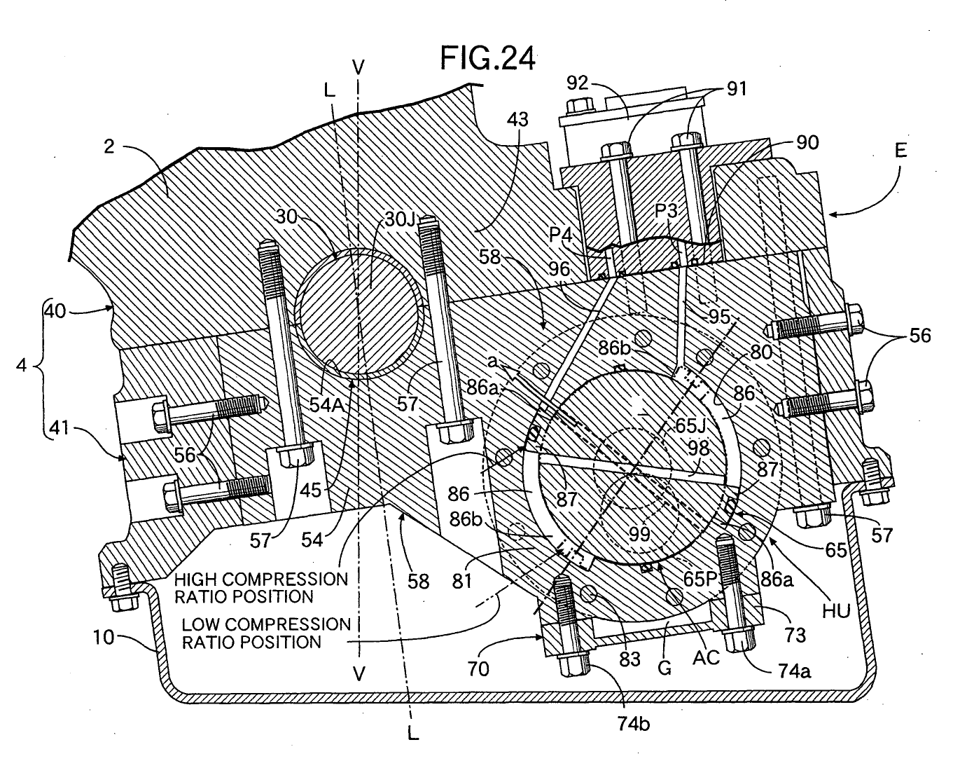

A tenth embodiment of the present invention is now explained by reference to FIG. 24.

In this tenth embodiment, a vane 87 of a hydraulic actuator AC is provided at a position that avoids the direction of a maximum radial load occurring in a vane shaft 66, thus enabling the radial clearance between the vane 87 and a vane chamber 86 of a housing HU to be set at a small value.

As shown in FIG. 24, the vane 87 housed in each of a pair of the vane oil chambers 86 is disposed at a position that avoids the direction of operation (direction shown by arrow a in FIG. 24) of a maximum load in a radial direction acting on a control shaft 65, that is, the vane shaft 66, and is preferably disposed at a position perpendicular to the direction of operation of the maximum load. In accordance with such positioning of the vane 87, the maximum load does not act between the outer periphery of the vane 87 and the inner periphery of the vane oil chamber 86 provided in the housing HU, and as a result even if the radial clearance is made small, there is no possibility of the outer periphery of the vane 87 and the inner periphery of the vane oil chamber 86 (inner face of the housing HU) interfering with each other.

When an engine E is made to run in the lowest low compression state, as shown by the broken line in FIG. 24, the pair of vanes 87 are held at a position close to a stopper face of the vane oil chamber 86, and a diameter line linking these vanes 87 is substantially perpendicular to the direction of operation of the maximum load (the direction shown by arrow a in FIG. 24). This still more reliably prevents the pair of vanes 87 from interfering with the housing HU, thus improving the performance of the actuator AC.

In this tenth embodiment, when the engine E is running, accompanying operation of a variable stroke link mechanism LV, the maximum load in the radial direction acts on the control shaft 65 through a control link 63 in the direction of the point where a lower link 60 and the control link 63 are linked, that is, in the direction of a second linking pin 64 (the direction shown by arrow a in FIG. 24), but since the maximum load does not act between the outer periphery of the vane 87 and the inner periphery of the vane oil chamber 87 of the housing HU, there is the advantage that the clearance therebetween can be set at a small value.

Particularly preferably, since, when the engine E is made to run in the lowest low compression ratio state, the maximum load becomes the greatest, by disposing the vane 87 (position shown by the broken line in FIG. 6) in a direction substantially perpendicular to the direction of operation of the maximum load at this time (the direction shown by arrow a in FIG. 24) this advantage can be exhibited more markedly.

As shown in FIG. 24, two communication oil paths 98 and 99 are bored in the vane shaft 66 in a crossed state on diameter lines while being spaced in the axial direction; one communication oil path 98 provides communication between a pair of control oil chambers 86b, and the other communication oil path 99 provides communication between a pair of control oil chambers 86a.

It is possible to form the housing HU of the vane type hydraulic actuator AC for driving the control shaft 65 compactly using a center bearing member of a lower block 41 (formed separately from the lower block 41 and fixed thereto) even with a small number of components, and the volume occupied by this housing HU within a crank chamber CC can be reduced, thereby suppressing any increase in the bulk of a crankcase.

In accordance with the tenth embodiment, since the vane 87 of the vane type hydraulic actuator AC is disposed at a position that avoids the direction of the maximum radial load occurring in the vane shaft 66 of the control shaft 65, it is possible to set the clearance between the outer periphery of the vane 87 and the inner periphery of the vane oil chamber 86 of the housing HU at as small a value as possible compared with that for a conventional actuator of this type, and an effect in greatly improving the performance of the actuator AC can be achieved; by preferably disposing the vane 87 in a direction perpendicular to the direction of the maximum load when a variable stroke characteristic engine E is in the lowest low compression ratio state, the effect becomes still more marked.

In this tenth embodiment, since the housing HU of the actuator AC is secured integrally to a high rigidity bearing block 70, the rigidity of the housing HU itself is enhanced and, furthermore, since a recess G is formed in a central housing receiving part 73 of the bearing block 70, and a lower part of the housing HU is housed in this recess G as a housing space, the actuator AC can be mounted compactly on the engine E with high rigidity, thereby contributing to a reduction in the dimensions of the engine E itself. Furthermore, among a plurality of securing bolts 74a and 74b securing the bearing block 70 to the housing HU, a securing bolt 74a provided in a thick wall part between adjacent vane oil chambers 86 is made longer than a securing bolt 74b provided so as to face the vane oil chamber 86, thereby still further enhancing the rigidity with which the housing HU and the bearing block 70 are secured.

### Embodiment 11

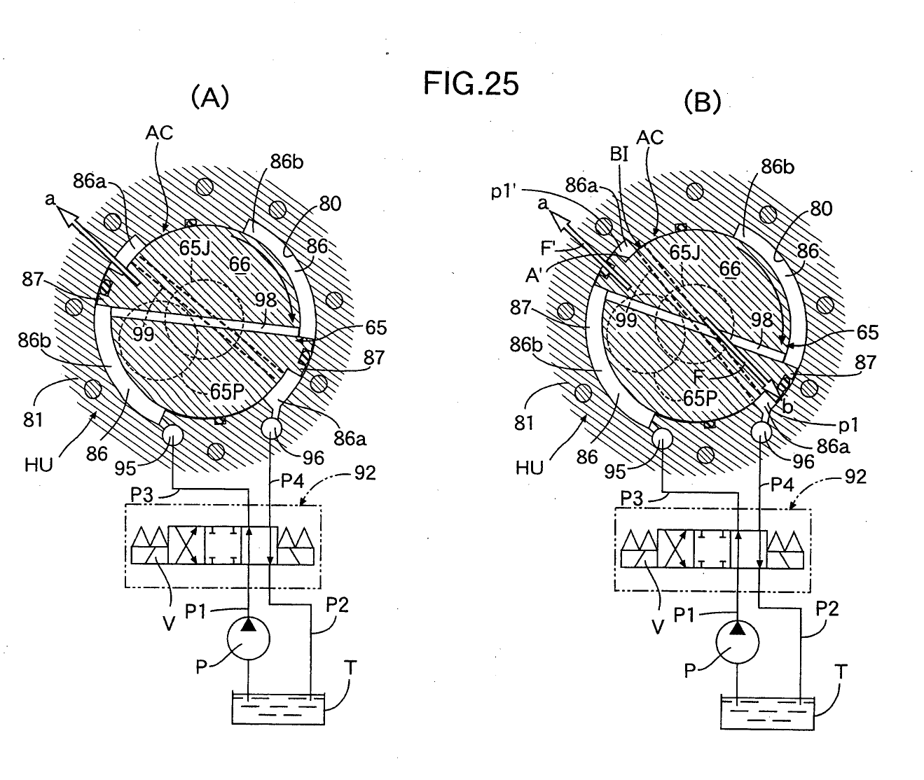

An eleventh embodiment of the present invention is explained by reference to FIG. 25. Two communication oil paths 98 and 99 are bored in a vane shaft 66 in a radially crossed state while being spaced in the axial direction; one communication oil path 98 provides communication between a pair of control oil chambers 86b, and the other communication oil path 99 provides communication between a pair of control oil chambers 86a. Supplying hydraulic oil from a hydraulic circuit selectively to the control oil chambers 86a and 86b enables the vane shaft 66 to be rotated forward and backward through a predetermined angle.

The interior of each of a pair of fan-shaped vane oil chambers 86 formed from the vane shaft 66 of a control shaft 65 and a housing HU is divided by a vane 87 into the two control oil chambers 86a and 86b, and these control oil chambers 86a and 86b are connected to an oil tank T via the hydraulic circuit. Connected to the hydraulic circuit are an oil pump P driven by a motor M, a check valve C, an accumulator A, and a solenoid switching valve V. The oil tank T, the motor M, the oil pump P, the check valve C, and the accumulator A form a hydraulic supply system, and are provided at an appropriate location on an engine main body 1, and the solenoid switching valve V is provided in the interior of a valve unit 92. The hydraulic supply system S and the solenoid switching valve V are connected by two oil paths P1 and P2, and the solenoid switching valve V and the control oil chambers 86a and 86b of the vane type hydraulic actuator AC are connected by two oil paths P3 and P4. Therefore, when the solenoid switching valve V is switched to a right position, hydraulic oil generated by the oil pump P is supplied to the control oil chamber 86b, the oil pressure pushes the vane 87, and the control shaft 65 rotates in a clockwise direction, whereas when the solenoid switching valve V is switched to a left position, the hydraulic oil generated by the oil pump P is supplied to the control oil chamber 86a, the oil pressure pushes the vane 87, and the control shaft 65 rotates in an anticlockwise direction; by so doing the phase of an eccentric pin 65P of the control shaft 65 changes. A control link 63 of a variable stroke link mechanism LV is swingably and pivotably supported on and linked to the eccentric pin 65P of the control shaft 65, and by driving the control shaft 65 (through about 90°), the variable stroke link mechanism LV is operated by the change in phase of the eccentric pin 65P of the control shaft 65.

When the engine E is running, in response to operation of the variable stroke link mechanism LV, a maximum load F′ (the maximum when the engine is made to run in a low compression ratio state) acts on the vane shaft 66 through the control link 63 in the direction of the point where a lower link 60 and the control link 63 are linked, that is, in the direction of a second linking pin 64 (direction shown by arrow a in FIG. 25), and this maximum load F′ increases the friction between bearing faces of the vane shaft 66 and a vane chamber 80, but in this eleventh embodiment, an urging force F (direction shown by arrow b in FIG. 25) in a direction opposite to the maximum load F′ (the direction shown by arrow a in FIG. 25) is applied to the vane shaft 66 by urging force imparting means BI formed from the communication oil path 99 formed in the vane shaft 66 and the inner periphery of the vane chamber 80, thus enabling the friction to be reduced. The operation of a cushion mechanism as the urging force imparting means BI, which imparts to the vane shaft 66 an urging force in a direction opposite to the direction of the maximum load acting on the vane shaft 66, is explained by reference to FIG. 25.

In a process in which the vane type hydraulic actuator AC is driven by hydraulic oil from the hydraulic circuit to thus operate the variable stroke link mechanism LV, as shown in FIG. 25 (A), the solenoid valve V is switched to the right position, hydraulic oil from the hydraulic pump P is supplied to the control oil chamber 86b and the communication oil path 98, and the hydraulic oil within the control oil chamber 86a and the communication oil path 99 returns to the oil tank T; the vane shaft 66 therefore rotates in a clockwise direction, the actuator AC is driven, and the variable stroke link mechanism LV is driven. When the vane shaft 66 continues to rotate in the clockwise direction and the vane 87 is about to reach a limit position (a position where change to a low compression ratio is completed), as shown in FIG. 25 (B), the communication oil path 99 is blocked by the inner periphery of the vane chamber 80 and communication between the opposing vane oil chambers 86a and 86a is cut off, and since one vane oil chamber 86a attains a sealed state and the other vane oil chamber 86a attains an open-to-atmosphere state (communicating with the oil tank T), an oil pressure p1′ within the one vane oil chamber 86a attains a high pressure and an oil pressure p1 within the other vane oil chamber 86a attains a low pressure (atmospheric pressure). When a pressure-receiving area on the outer periphery of the vane shaft 66 on which the oil pressure p1′ within the one vane oil chamber 86a acts is defined as A′, an urging force F [F=(p1′−p1)×A′] in a direction (the direction shown by arrow b in FIG. 25) opposite to that of the maximum load F′ is generated on the vane shaft 66, and since this urging force F can generate a cushioning action in the vane shaft 66 against the maximum load F′, friction acting on the bearing faces of the vane shaft 66 and the control shaft 65 can be reduced.

In accordance with the eleventh embodiment, since the friction of the bearing faces of the vane shaft 66 and the control shaft 65 in the maximum load direction is reduced, the responsiveness of the vane type hydraulic actuator AC can be improved, any increase in the driving force of the actuator AC can be suppressed and, moreover, the possibility of oil layer breaks occurring on the bearing faces of the vane shaft 66 and the control shaft 65 can be suppressed.

Furthermore, since the communication state between the vane oil chamber 86 and the communication oil path 99 provided in the vane shaft 66 is restricted before the limit position (low compression ratio position) in the direction of rotation of the vane shaft 66 of the actuator AC, an urging force in the opposite direction to that of the maximum load acting on the vane shaft 66 can be generated without making any changes in the structural arrangement of the oil path.

Moreover, since the communication oil path 99 forming the urging force imparting means BI is formed linearly in the radial direction of the vane shaft 66, the machining time therefor can be reduced; furthermore, any decrease in the rigidity of the vane shaft 66 can be suppressed and, moreover, compared with one in which the communication oil path 99 is formed by providing communication between a plurality of oil paths in a crossed state, it is unnecessary to use blanking plug.

### Embodiment 12

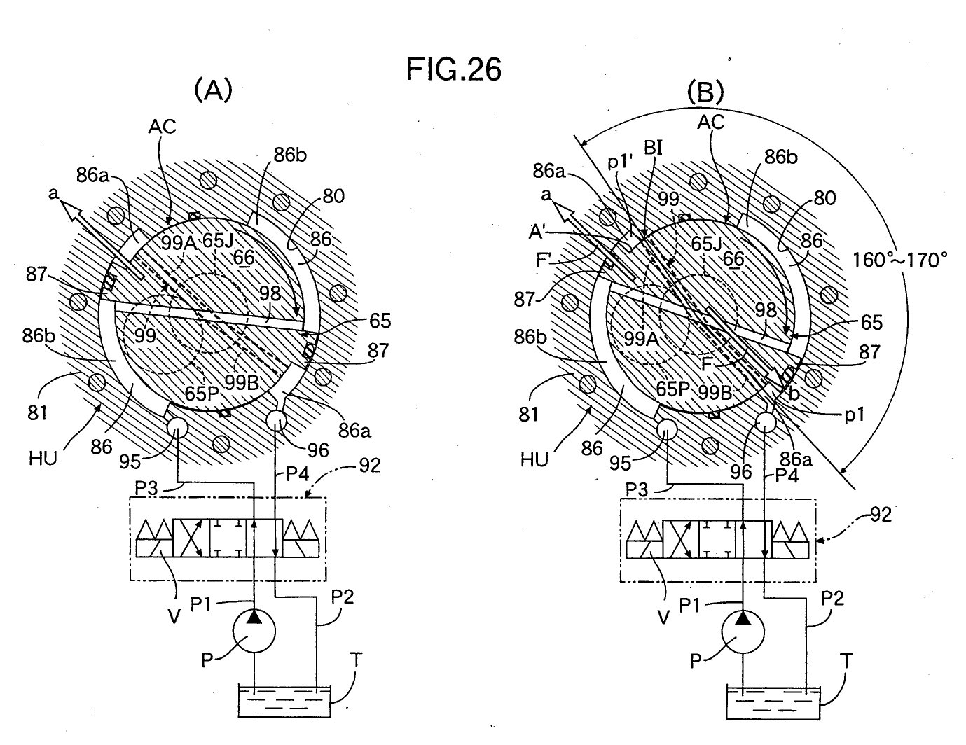

A twelfth embodiment of the present invention is now explained by reference to FIG. 26.

This twelfth embodiment is slightly different from the eleventh embodiment with respect to the structure of a communication oil path 99 formed in a vane shaft 66.

A communication passage half 99A on one side of the communication oil path 99 that communicates with one of opposing control oil chambers 86a and a communication passage half 99B on the other of the communication oil path 99 that communicates with the other one of the opposing control oil chambers 86a are each formed linearly, and relative to the communication passage half 99A on the one side the communication passage half 99B on the other side is formed so as to bend at a predetermined angle in a central part of a vane shaft 66, the angle at which this communication passage 99 is bent being set at 160° to 170°.

In the same way as for the eleventh embodiment, the vane shaft 66 rotates in a clockwise direction as shown in FIG. 26 (A), and the actuator AC is driven. When the vane shaft 66 continues to rotate in the clockwise direction and a vane 87 is about to reach a limit position (a position where change to a low compression ratio is completed), as shown in FIG. 26 (B), with regard to the communication oil path 99, one open end thereof is blocked by the inner periphery of a vane chamber 80, and the other open end thereof communicates with the vane oil chamber 86a. In the same way as for the eleventh embodiment, this enables an urging force F in a direction opposite to that of a maximum load F′ to be generated in the vane shaft 66.

Since the communication passage half 99A on one side that communicates with one of the opposing control oil chambers 86a and the communication passage half 99B on the other side that communicates with the other one of the opposing control oil chambers 86a are each formed linearly, and relative to the communication passage half 99A on the one side the communication passage half 99B on the other side is formed so as to bend at a predetermined angle in a central part of the vane shaft 66, it is possible to easily form the communication oil path 99 with high machining precision and suppress any decrease in the rigidity of the vane shaft 66.

Moreover, even when the vane 87 reaches the limit position and the vane shaft 66 does not rotate, since the communication oil path 99 maintains a communication state with a hydraulic circuit, and oil is supplied thereto, the responsiveness of the actuator AC can be yet further improved.

### Embodiment 13

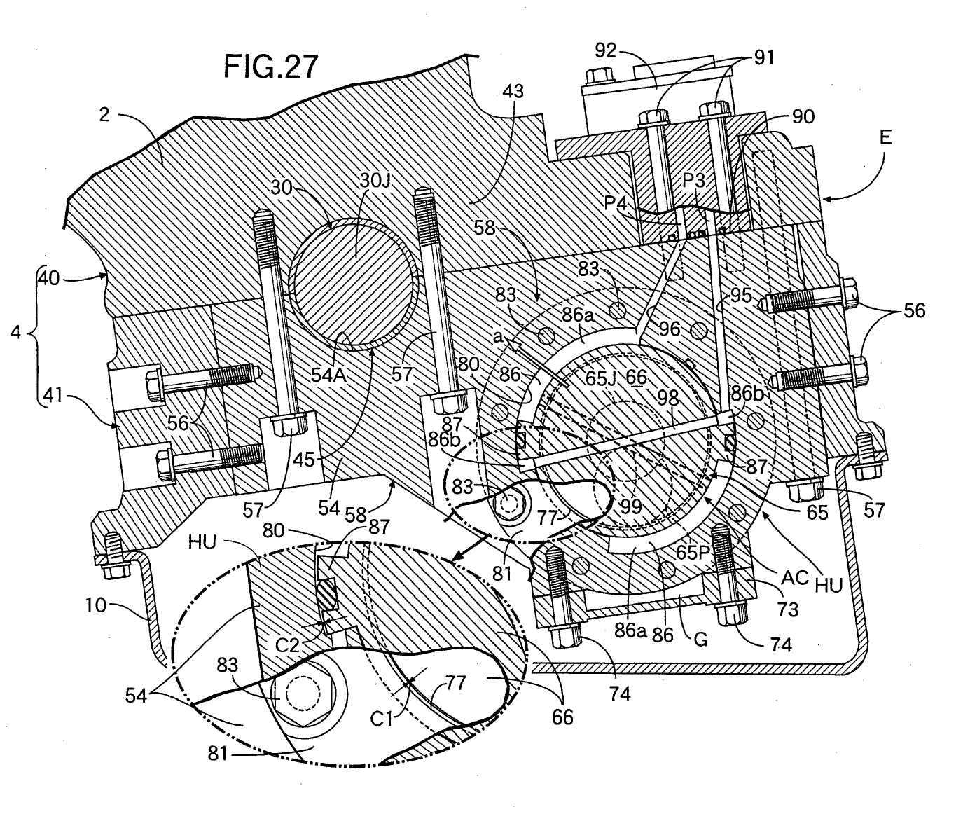

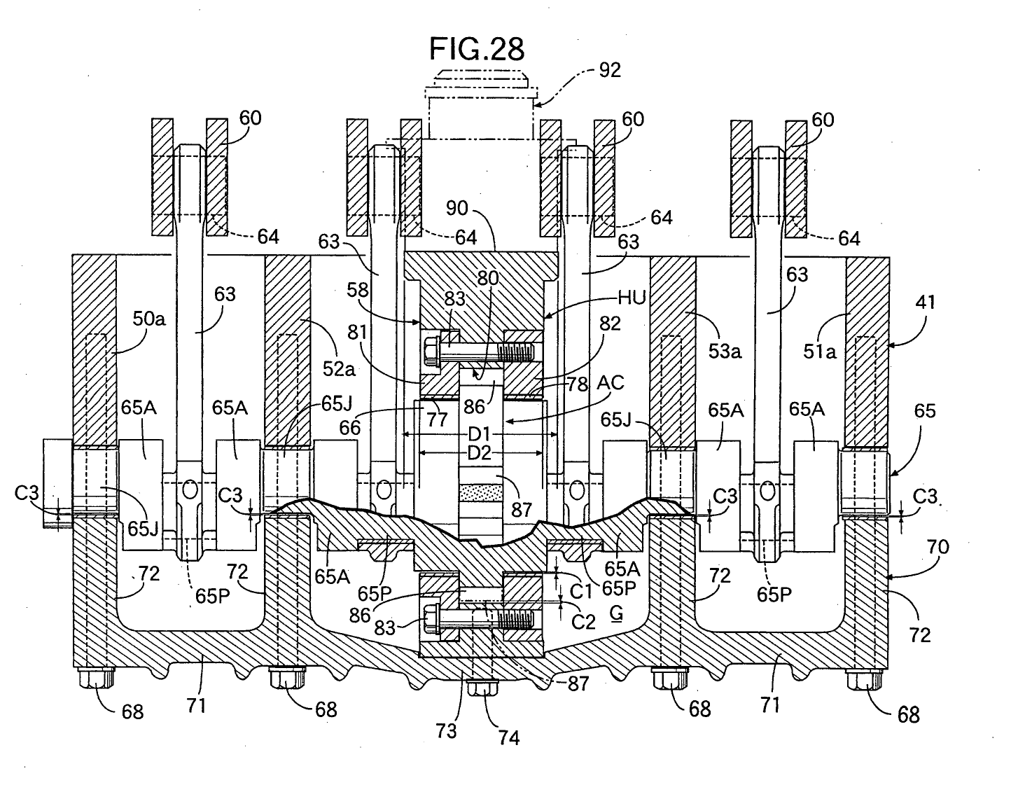

A thirteenth embodiment of the present invention is now explained by reference to FIGS. 27 and 28.

In this thirteenth embodiment, a maximum load generated in a control shaft 65 is received between a bearing of a housing HU and a vane shaft 66, a vane 87 does not interfere with the housing HU, and the position of the vane 87 can be set freely. As shown in FIGS. 27 and 28, a pair of fan-shaped vane oil chambers 86 are defined between the inner periphery of a vane chamber 80 and the outer periphery of the vane shaft 66 with a phase difference of about 180°, a pair of the vanes 87 projectingly provided integrally with the outer periphery of the vane shaft 66 are housed within these vane oil chambers 86, and the outer periphery of the vanes 87 is in sliding contact with the inner periphery of the vane oil chamber 86. Each vane 87 oil-tightly divides the interior of the fan-shaped vane oil chamber 86 into two control oil chambers 86a and 86b.

Two communication oil paths 98 and 99 are bored in the vane shaft 66 on diameter lines in a crossed state while being spaced in the axial direction; one communication oil path 98 provides communication between a pair of the control oil chambers 86b and the other communication oil path 99 provides communication between a pair of the control oil chambers 86a.

As shown in FIG. 27, a radial clearance C1 between a bearing face of vane bearings 81 and 82 of the housing HU and left and right bearings of the vane shaft 66 is set smaller than a radial clearance C2 between the inner periphery of the vane oil chamber 86 and the outer periphery of the vane 87. Because of this, when a radially unbalanced load acts on the vane shaft 66, it is possible to prevent the outer periphery of the vane 87 from interfering with the inner periphery of the vane chamber 80, thus preventing the occurrence of ‘galling’ between the outer periphery of the vane 87 and the inner periphery of the vane oil chamber 86.

When the engine E is running, accompanying operation of a variable stroke link mechanism LV, the maximum load acts on the control shaft 65 through a control link 63 in the direction of the point where a lower link 60 and the control link 63 are linked, that is, in the direction of a second linking pin 64 (the direction shown by arrow a in FIG. 27), but by setting the clearances C1 and C2 (C1<C2), even such a maximum load does not cause the vane 87 to interfere with the inner periphery of the vane oil chamber 86. With regard to a vane type actuator AC, positioning of the vane oil chamber 86 and the vane 87 can be set freely.

Furthermore, as shown in FIG. 28, a clearance C3 is formed between a bearing face of a bearing wall 72 supporting the control shaft 65 and the outer periphery of the control shaft 65; this clearance C3 is set smaller than the radial clearance C2 between the inner periphery of the vane oil chamber 86 and the outer periphery of the vane 87 (C3<C2), the maximum load generated in the control shaft 65 can thereby be received between the bearing face of the bearing wall 72 supporting the control shaft 65 and the control shaft 65, and the vane 87 is prevented from interfering with the housing HU. Moreover, the clearance C1 between a bearing face of the housing HU and the outer periphery of the left and right bearings of the vane shaft 66 is set smaller than the clearance C3 between the bearing face of the bearing wall 72 supporting the control shaft 65 and the outer periphery of the control shaft 65 (C1<C3). This enables deformation such as flexure to be made smaller for the vane shaft 66 than the control shaft 65, the clearance C1 to be made small, and rattling of the vane 87 to be suppressed, thereby improving the sealing properties of the vane chamber 80.

In accordance with the thirteenth embodiment, the radial clearance C1 between the bearing face of the vane bearings 81 and 82 of the housing HU and the outer periphery of the vane shaft 66 is set smaller than the radial clearance C2 between the inner periphery of the vane oil chamber 80 and the outer periphery of the vane 87 (C1<C2), the maximum load occurring in the control shaft 66 can be received between the bearing face of the housing HU and the vane shaft 66, the maximum load does not cause interference between the outer periphery of the vane 87 and the inner periphery of the vane chamber 80, and the positions of the vane chamber 80 and the vane 87 can therefore be freely set.

Furthermore, the maximum load generated in the control shaft 65 can be received between the bearing face of the bearing wall 72 supporting the control shaft 65 and the control 65 shaft, the vane 87 does not interfere with the housing HU, and the position of the vane 87 can therefore be freely set.

Moreover, since the bearing gap of the bearing of the vane shaft 66 is smaller than the bearing gap of a journal shaft part 65J of the control shaft 65, deformation such as flexure is made smaller for the vane shaft 66 than the control shaft 65, the radial clearance between the bearing face of the housing HU and the outer periphery of the vane shaft 66 is made smaller to thus suppress fluctuation (rattling) of the vane, and it is thereby possible to set the clearance between the vane 87 and the housing HU at a small value, thus improving the sealing properties of the vane chamber 80.

Furthermore, while suppressing friction of the journal shaft 65J of the control shaft 65 (since the bearing area can be reduced due to a small diameter), the rigidity of the vane 87 can be guaranteed (it is easy to guarantee bearing area if the diameter is large), and any increase in the width of the vane shaft 66 in the crankshaft direction can be suppressed.

Since the positioning of the plurality of vane chambers 80 and vanes 87 of a vane type hydraulic actuator AC can be set freely, oil paths 95 and 96 providing communication between the vane chamber 80 and a valve unit 92 can be made in a linear form, the oil path structure can thereby be simplified and thus be easily formed, and the responsiveness of the vane type hydraulic actuator is improved.

### Embodiment 14

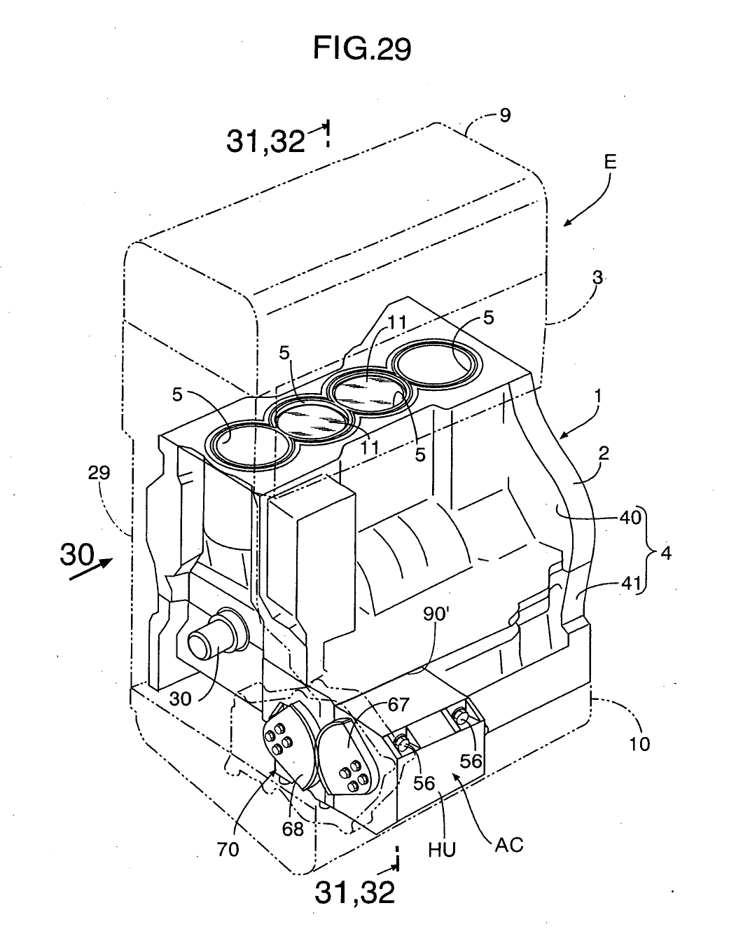

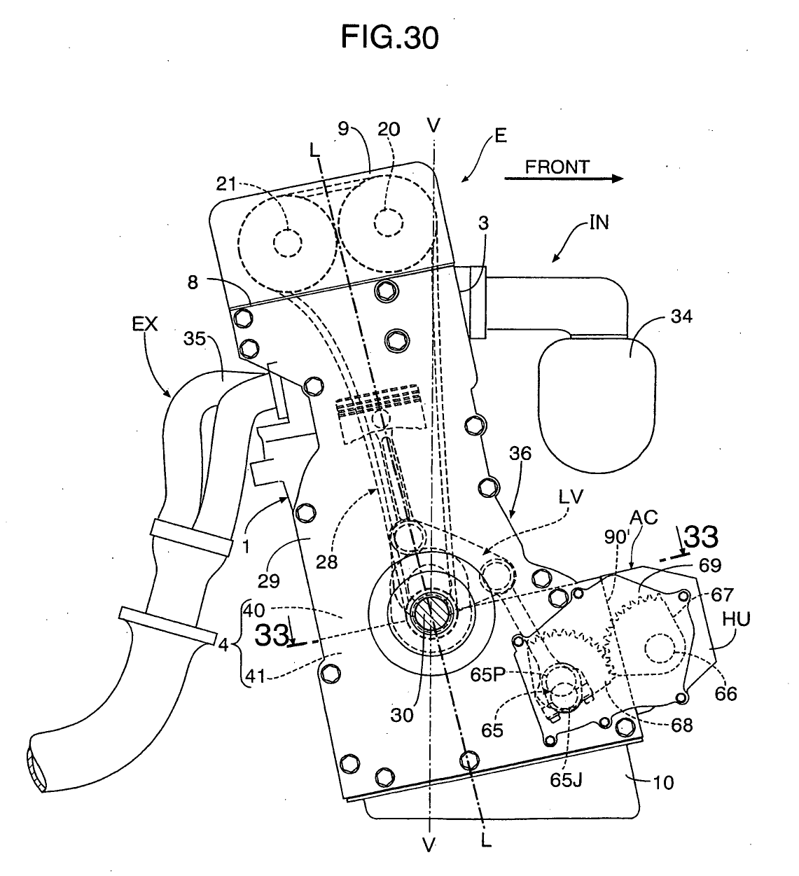

A fourteenth embodiment of the present invention is now explained by reference to FIGS. 29 to 36.

In this fourteenth embodiment, a housing HU of an actuator AC operating a variable stroke link mechanism LV is mounted on a high rigidity engine main body 1, thus enhancing the rigidity with which the actuator AC is mounted.

A variable stroke characteristic engine E is the same in-line four-cylinder OHC type four-cycle engine as in the first embodiment, and detailed explanation thereof is therefore omitted.

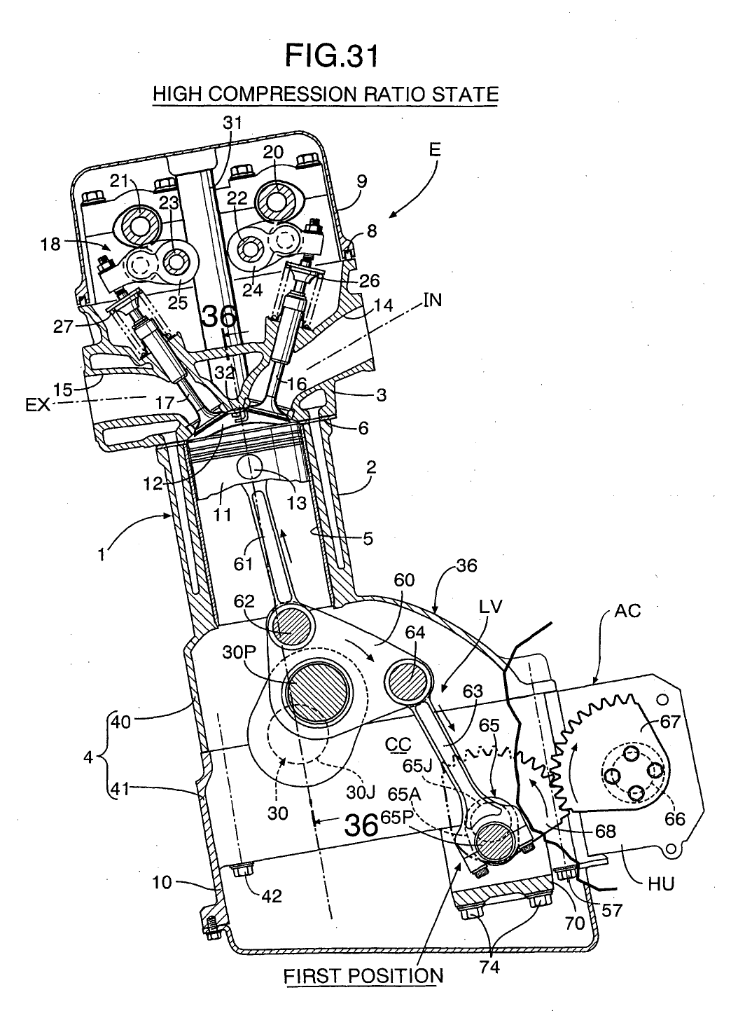

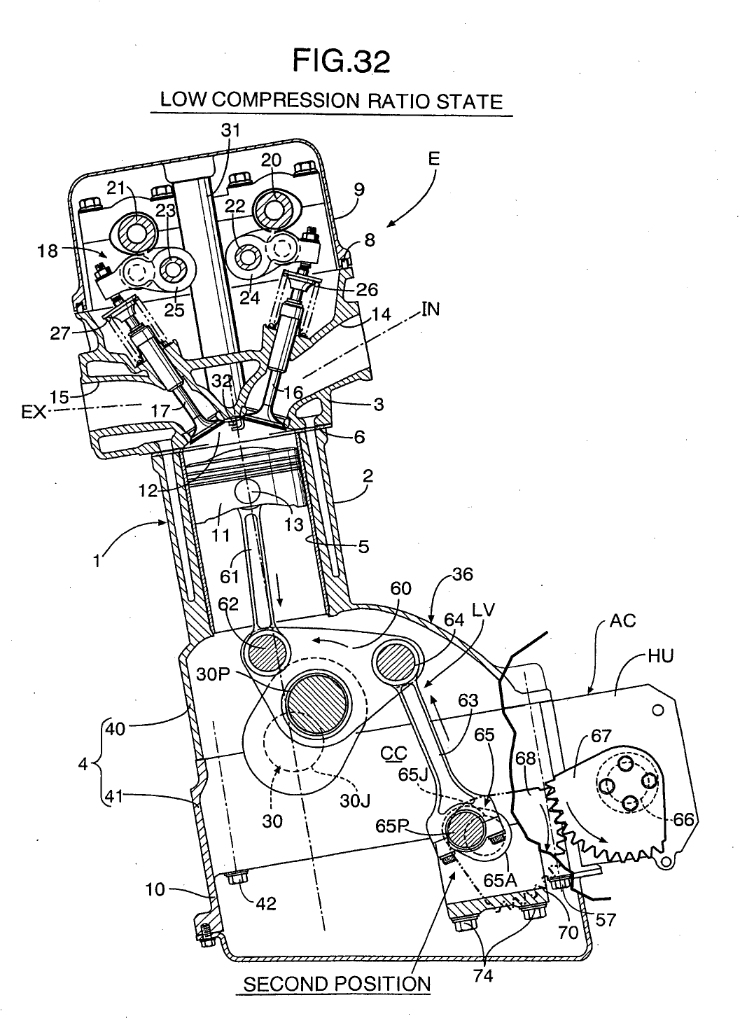

As shown in FIGS. 31 and 32, a crankcase 4, which is formed from an upper block 40 (upper crankcase) on a lower part of a cylinder block 2 and a lower block 41 (lower crankcase), protrudes toward the front (front of the vehicle) relative to a cylinder 5 portion of the cylinder block 2, the variable stroke link mechanism LV that makes the stroke travel of pistons 11 variable is provided within a crank chamber CC of this protruding portion 36, and the actuator AC driving the variable stroke link mechanism LV is provided on a front face 90′ of a lower part of the engine main body 1, the actuator AC being disposed beneath a crankshaft 30.

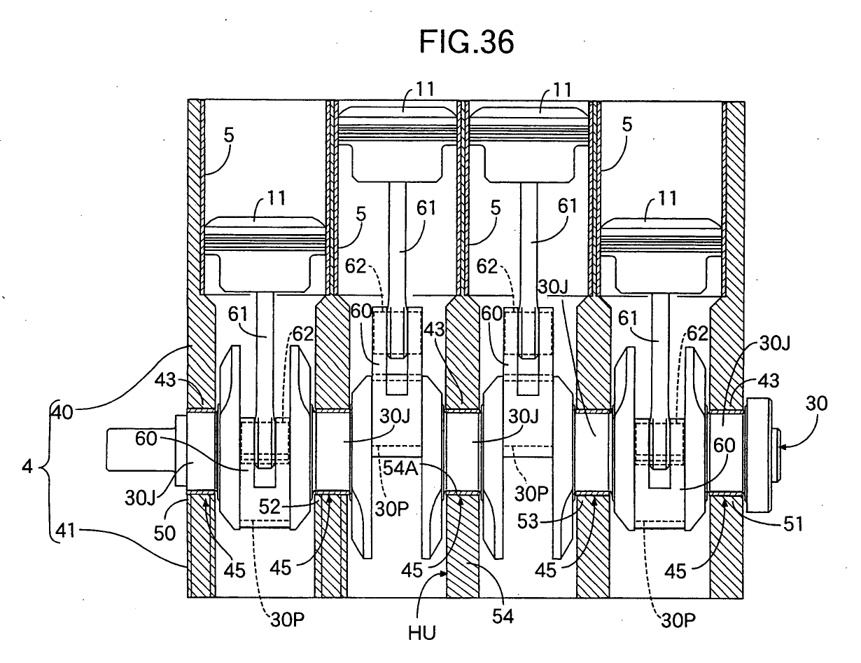

As shown in FIGS. 31 to 33, and FIG. 36, the lower block 41 is fixed via a plurality of linking bolts 42 to a lower face of the upper block 40, which is integrally formed with the lower part of the cylinder block 2. Journal shafts 30J of the crankshaft 30 are rotatably supported on a plurality of journal bearings 43 formed between mating surfaces of the upper block 40 and the lower block 41 (see FIG. 36).

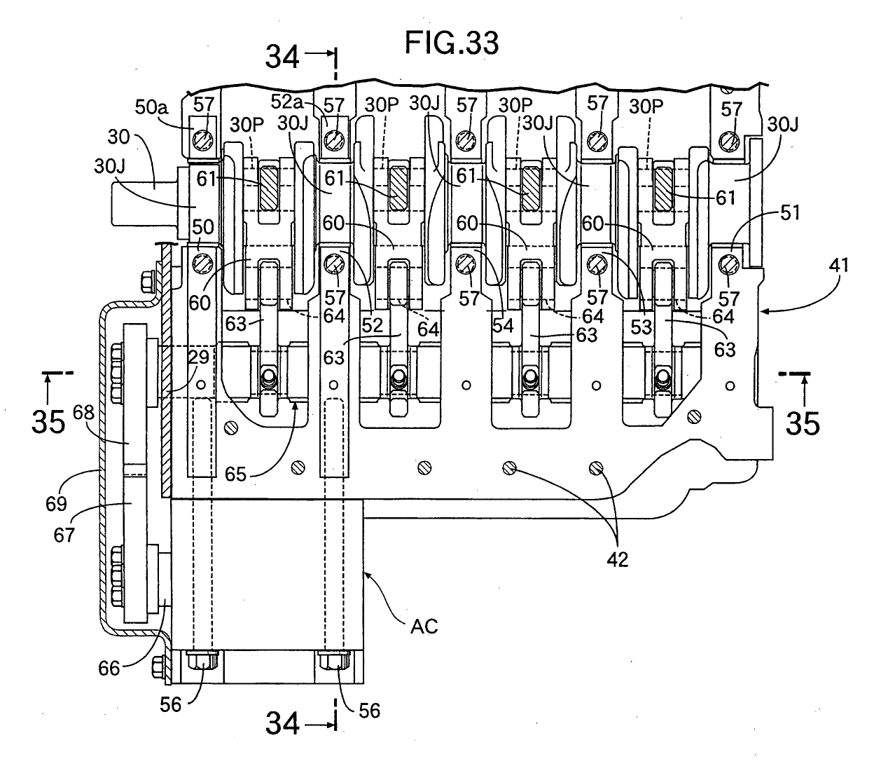

As shown in FIG. 33, the lower block 41 is cast-molded in a structure having a rectangular closed section in plan view, left and right end sections thereof are provided with end section crank bearing members 50 and 51, a middle section thereof is provided with left and right middle section crank bearing members 52 and 53, and the center thereof is provided with a center crank bearing member 54, and the journal shafts 30J of the crankshaft 30 are rotatably supported by these crank bearing members 50 to 54.

The variable stroke link mechanism LV, which varies the compression ratio between a high compression ratio and a low compression ratio by changing the top dead center and bottom dead center positions of the pistons 11, is the same as that of the first embodiment, and detailed explanation thereof is therefore omitted.

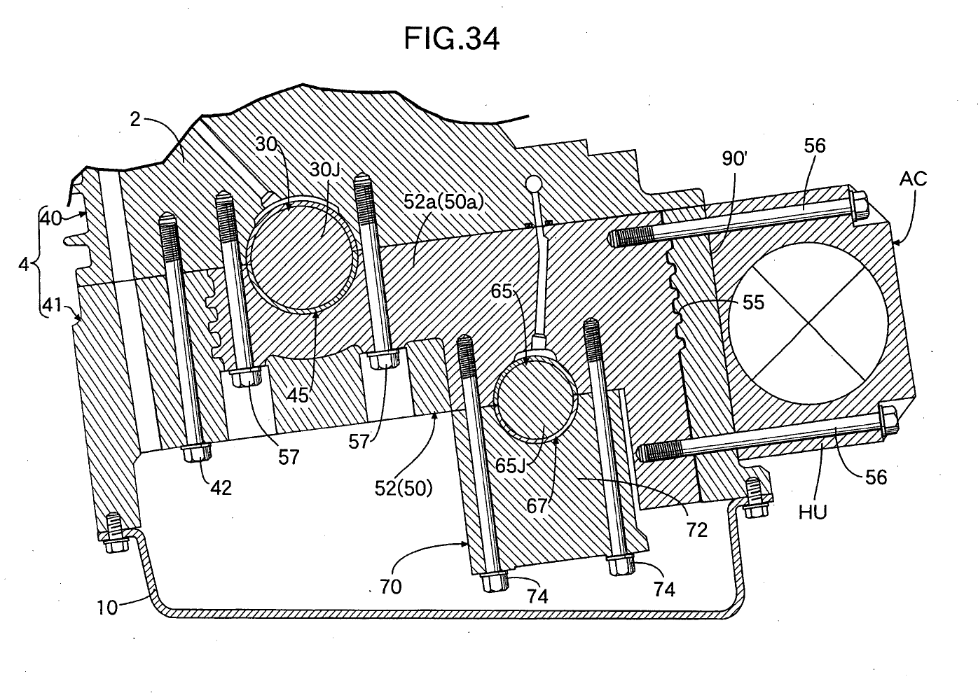

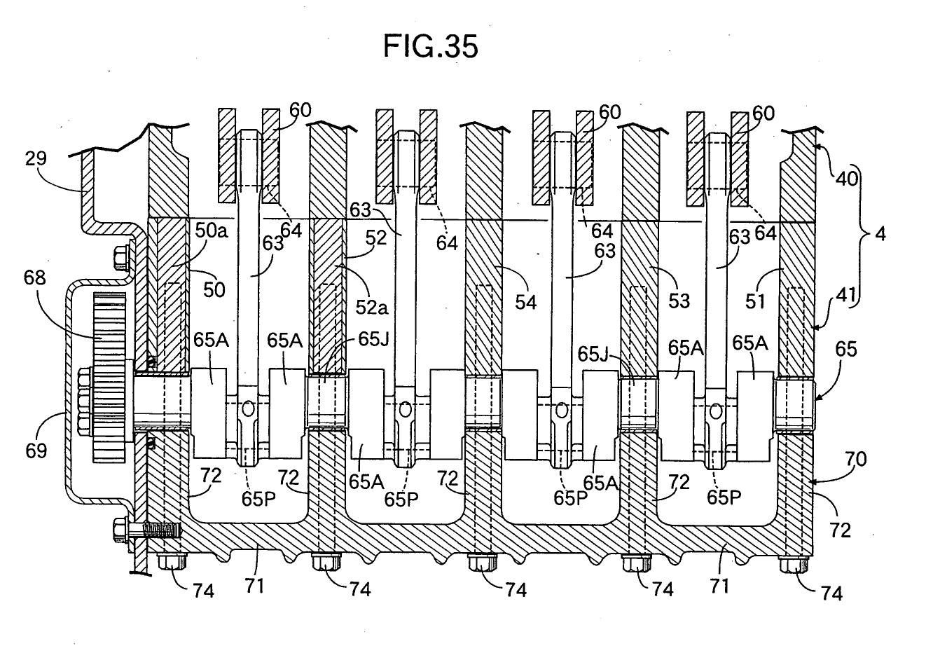

As shown in FIGS. 34 and 35, a control shaft 65, which is linked to the control link 63 and operates the variable stroke link mechanism LV, is formed, in the same way as the crankshaft 30, in a crank shape, in which a plurality of the journal shafts 65J and eccentric pins 65P are alternately joined via arms 65A. The actuator AC is linked to one end of the control shaft 65, which is made to reciprocate through a predetermined angular range by the actuator AC. The control shaft 65 is disposed in parallel to the crankshaft 30, and is rotatably supported, beneath the crankshaft 30, between the lower block 41 and a bearing block 70 fixed to a lower face of the lower block 41 via a plurality of linking bolts 74.

The bearing block 70 supporting the control shaft 65 is cast-molded in a block shape with a linking member 71 extending in the axial direction of the control shaft 65 and a plurality of bearing walls 72 joined integrally to and rising from the linking member 71 while being spaced in the longitudinal direction thereof so as to guarantee high rigidity, and the plurality of journal shafts 65J of the control shaft 65 are rotatably supported via face bearings by bearings formed on mating surfaces of upper faces of the plurality of bearing walls 72 and lower faces of the crank bearing members 50 to 54 of the lower block 40.

As shown in FIGS. 33 and 34, among the plurality of crank bearing members 50 to 54 of the lower block 41, high rigidity bearing walls 50a and 52a are cast-molded integrally with the adjacent end crank bearing member 50 and middle crank bearing member 52, faces 55 with projections and recesses are formed on opposite outside faces in the width direction of these high rigidity bearing walls 50a and 52a, and the strength with which they are joined to the crank bearing members 50 and 52 by casting is increased. For example, when the crank bearing members 50 and 52 are formed from an aluminum alloy material, the high rigidity bearing walls 50a and 52a are formed from an iron material or a fiber-reinforced composite material (FRM).

As shown in FIG. 34, upper faces of the high rigidity bearing walls 50a and 52a are in direct contact with the lower face of the upper block 41 and are secured to the upper block 41 via a plurality of securing bolts 57. A semicircular lower half of a journal bearing 45 for the crankshaft 30 is formed on one side of the upper faces of the high rigidity bearing walls 50a and 52a, and a semicircular upper half of a journal bearing for the control shaft 65 is formed on the other side on the lower face thereof. The crankshaft 30 and the control shaft 65 are supported by the high rigidity bearing walls 50a and 52a.

Since the high rigidity bearing walls 50a and 52a are cast-molded specifically on the adjacent end crank bearing member 50 and middle crank bearing member 52, it is possible to enhance the rigidity with which the housing HU of the actuator AC is mounted, as described later, while guaranteeing the rigidity with which the crankshaft 30 and the control shaft 65 are supported.

Furthermore, the bearing block 70 secured to the lower face of the lower block 41 and supporting the control shaft 65 in cooperation with the lower block 41 may be formed from the same material as that for the lower block 41, or may be formed from the same material as that for the high rigidity bearing walls 50a and 52a.

As shown in FIGS. 29 to 34, the actuator AC for driving the control shaft 65 is supported integrally on the front face 90′ of the lower block 41 of the engine main body 1 while being biased to one side in the crankshaft 30 direction. The housing HU of the actuator AC is fixed to the front face 90′ of the lower block 41 via a plurality of securing bolts 56 running through the housing HU and the lower block 41 and secured to the high rigidity bearing walls 50a and 52a. The housing HU of the actuator AC therefore utilizes the high rigidity bearing walls 50a and 52a and is mounted thereon, and the rigidity with which it is mounted can be enhanced. Furthermore, the housing HU of the actuator AC and the high rigidity bearing walls 50a and 52a are together secured to the lower block 41 via the plurality of securing members 56, thus making it possible to reduce the number of securing members 56.

As the actuator AC, a conventionally known type such as a vane type hydraulic motor, an electric motor, or a hydraulic cylinder may be used. As shown in FIGS. 29 to 33, a drive sector gear 67 fixed to the outer end of an output shaft 66 of the actuator AC meshes with a driven sector gear 68 fixed to the outer end of the control shaft 65, the control shaft 65 can be rotated forward and backward through a predetermined angular range by the drive of the actuator AC, and the variable stroke link mechanism LV can be driven. The drive and driven sector gears 67 and 68 are covered by a cover 69 bolted to an end face of the engine main body 1 via a chain case 29.

As described above, in accordance with the fourteenth embodiment, since the actuator AC is mounted on the high rigidity crank bearing members 50 and 52, the rigidity of mounting can be improved, and in particular securing the actuator AC to the high rigidity bearing walls 50a and 52a with which the crank bearing members 50 and 52 are cast enables the rigidity of mounting to be further improved.

Since the housing HU of the actuator AC is mounted so as to straddle a plurality of high rigidity crank bearing members 50 and 52, the rigidity of mounting of the actuator AC is further improved, the housing HU of the actuator AC functions as a linking member providing a link between the plurality of crank bearing members 50 and 52, and the rigidity with which the crankshaft 30 is supported is also improved.

Moreover, since the crank bearing members 50 and 52 are formed integrally with the lower block 41 forming the engine main body 1 and cast with the high rigidity bearing walls 50a and 52a, which have higher rigidity than the lower block 41, and the housing HU of the actuator AC is supported on the lower block 41 by the securing members 56 secured to the high rigidity bearing walls 50a and 52a, the rigidity with which the actuator AC is secured to the engine main body 1 is greatly improved, and the rigidity of mounting of the actuator AC and the rigidity of the lower block 41 are both improved.

Furthermore, the housing HU of the actuator AC and the high rigidity bearing walls 50a and 52a are together secured to the crank bearing members 50 and 52 by the securing members 56, the rigidity with which the actuator AC is secured to the lower block 41 improves, the number of components can be decreased by reducing the number of securing members 56 and, moreover, any increase in dimensions in a direction intersecting the crankshaft 30 of the engine main body 1 can be suppressed.

### Embodiment 15

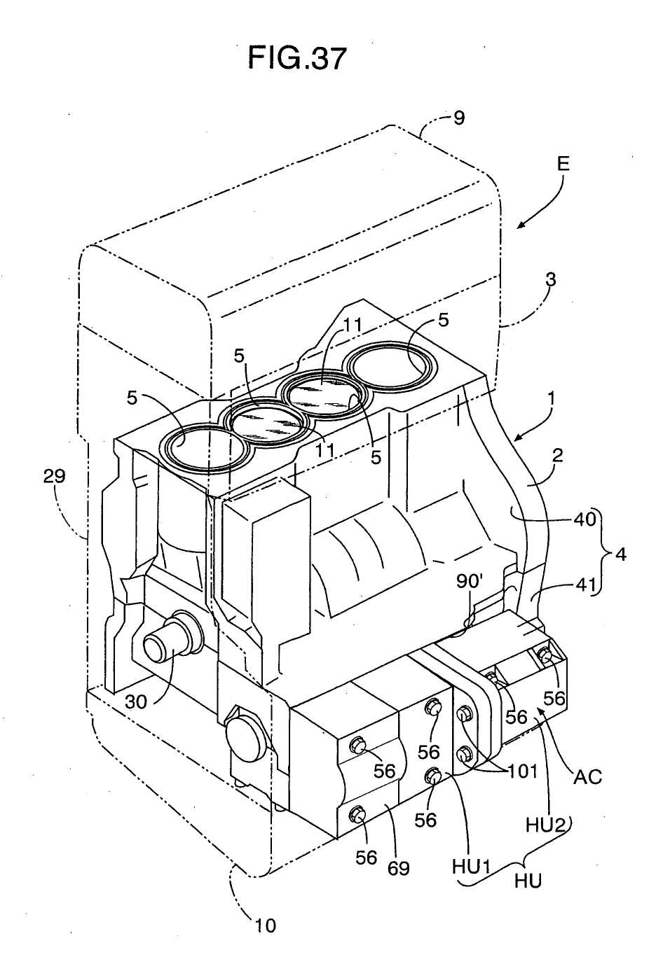

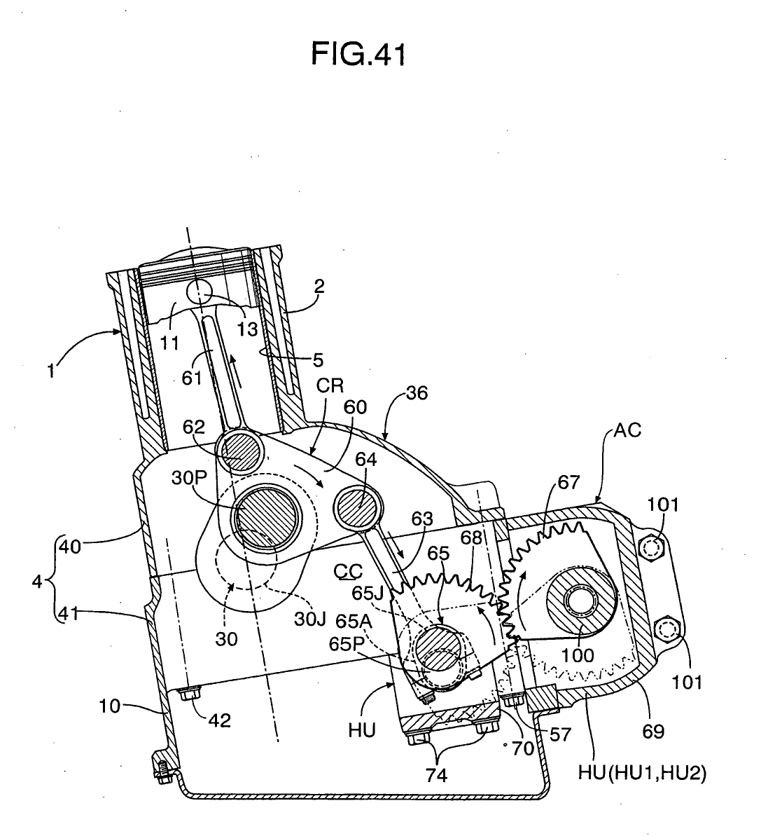

A fifteenth embodiment of the present invention is now explained by reference to FIGS. 37 to 41.

In this fifteenth embodiment, an actuator AC is fixed to a lower part of a front face of an engine main body 1, that is, a front face 90′ of a lower block, via a plurality of securing bolts 56.

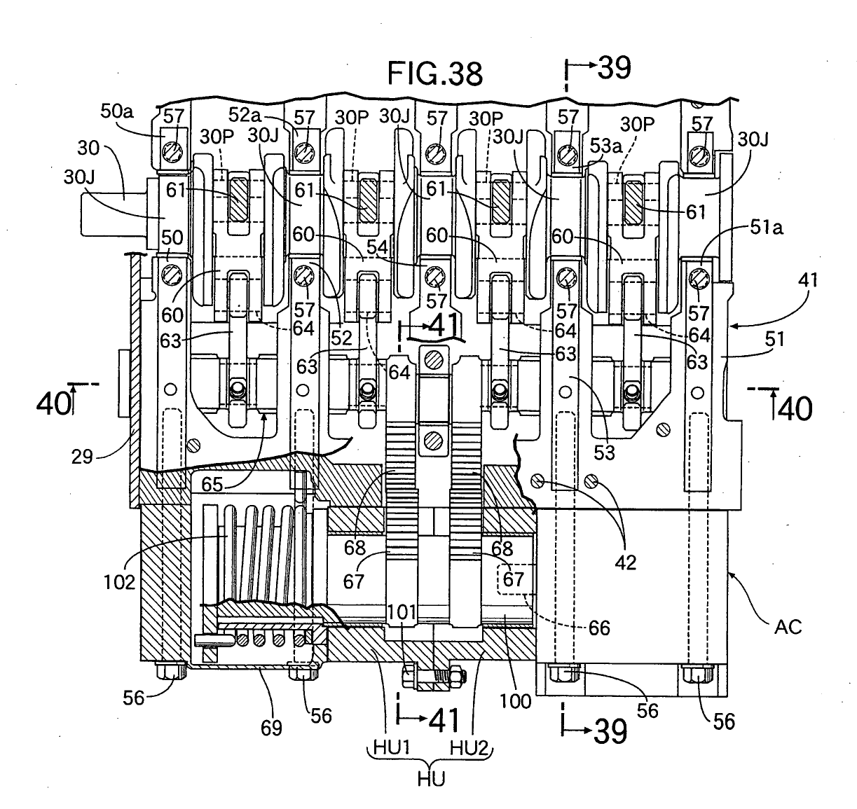

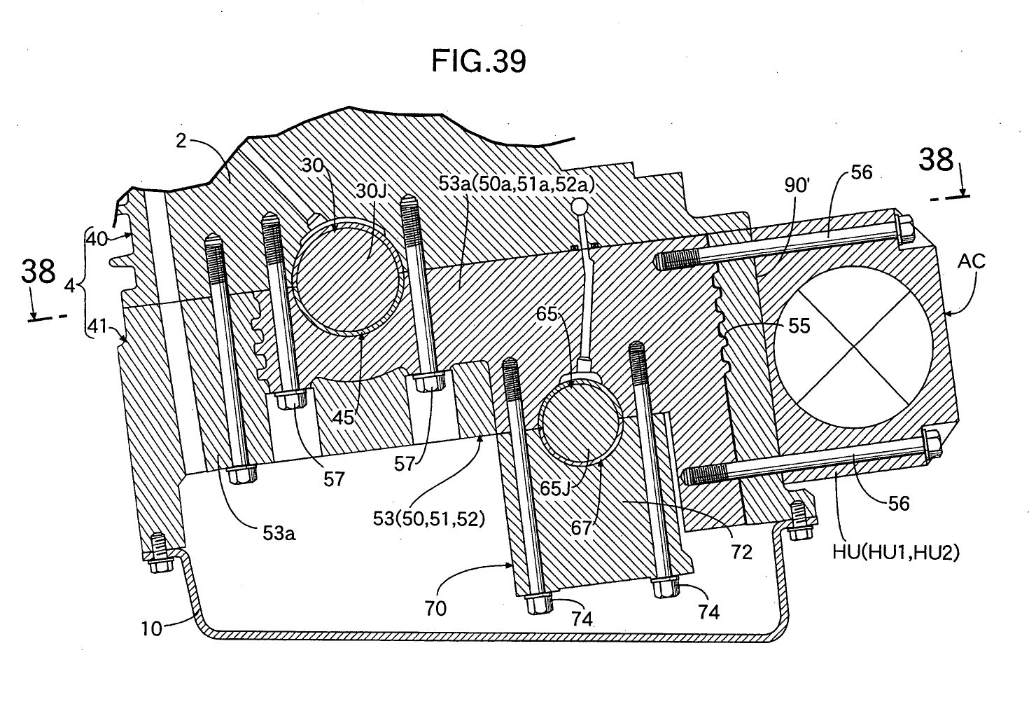

As shown in FIGS. 37 and 38, among a plurality of crank bearing members 50 to 54 formed in a lower block 41, excluding the center bearing member 54, left and right end crank bearing members 50 and 51 and middle crank bearing members 52 and 53 are selected, high rigidity bearing walls 50a, 51a, 52a, and 53a (the same as the high rigidity bearing walls 50a and 52a of the first embodiment) are cast-molded thereon, and the actuator AC is fixed to these high rigidity bearing walls 50a to 53a via the plurality of securing bolts 56. That is, as shown in FIG. 39, with regard to the plurality of securing bolts 56, the plurality of securing bolts 56 running through a housing HU and the crank bearing members 50 to 53 (lower block 41) from the outside of the actuator AC are secured to the high rigidity bearing walls 50a to 53a. This enhances the rigidity with which the actuator AC is mounted on the engine main body 1, and the housing HU of the actuator AC and the high rigidity bearing walls 50a to 53a are together secured to the lower block 41 by the securing bolts 56.

As shown in FIG. 38, the housing HU of the actuator AC is divided into a first housing HU1 and a second housing HU2, and they are joined integrally by a plurality of linking bolts 101. A drive shaft 100 extending in a crankshaft 30 direction is linked to an output shaft 66 of the actuator AC. This drive shaft 100 is rotatably supported within the housing HU via a bearing, and a pair of drive sector gears 67 are fixed to a middle section thereof. These drive sector gears 67 mesh with a pair of driven sector gears 68 fixed to a middle section of the control shaft 65, and in the same manner as in the first embodiment the control shaft 65 is driven forward or backward through a predetermined rotational angle by the drive of the actuator AC.

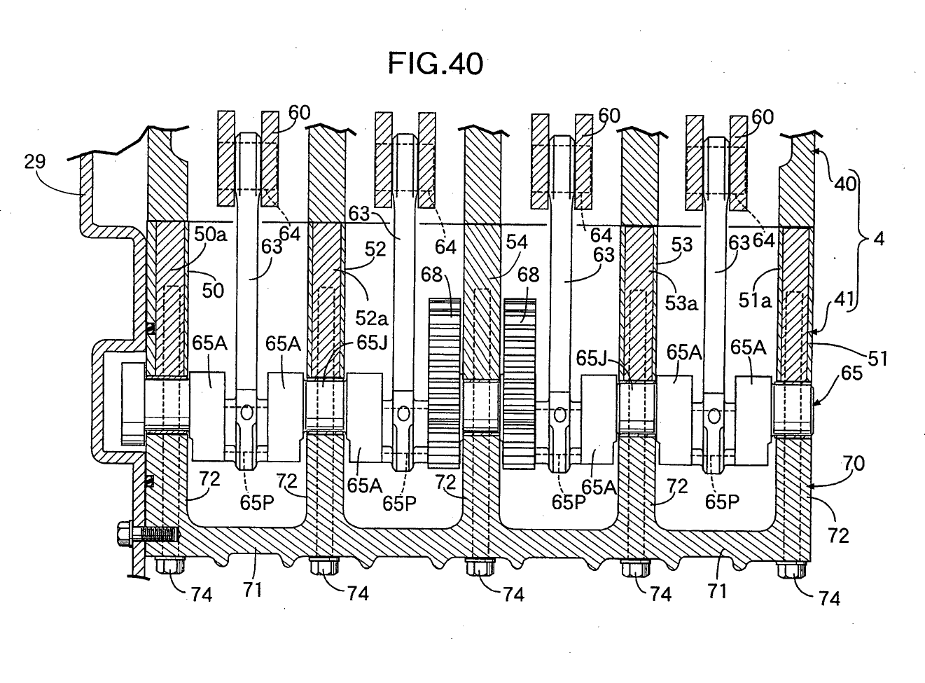

As shown in FIG. 40, a cover covering the control shaft 65 is formed integrally with a chain case 29, and any increase in the number of components is suppressed.

A coil spring 102 is provided at one end of the drive shaft 100. This coil spring 102 has one end thereof engaging with the drive shaft 100 and the other end engaging with a fixed part such as a lower housing 41, and urges the drive shaft 100 to rotate in one direction, thus rapidly changing the compression ratio of the variable stroke link mechanism LV. In this fifteenth embodiment, since the control shaft 65 is urged via the drive shaft 100 by the coil spring 102 in the rotational direction to the high compression ratio side, change of the compression ratio from a low compression ratio to a high compression ratio is carried out rapidly.

In accordance with this fifteenth embodiment, since the housing HU of the actuator AC is fixed to the crank bearing members 50 to 53 by the securing members 56 secured to each of the high rigidity bearing walls 50a to 53a cast with the crank bearing members 50 to 53, the rigidity with which the actuator AC is mounted on the engine main body 1 is enhanced.

In accordance with the fifteenth embodiment, the same operational effects as the fourteenth embodiment are exhibited.

### Embodiment 16

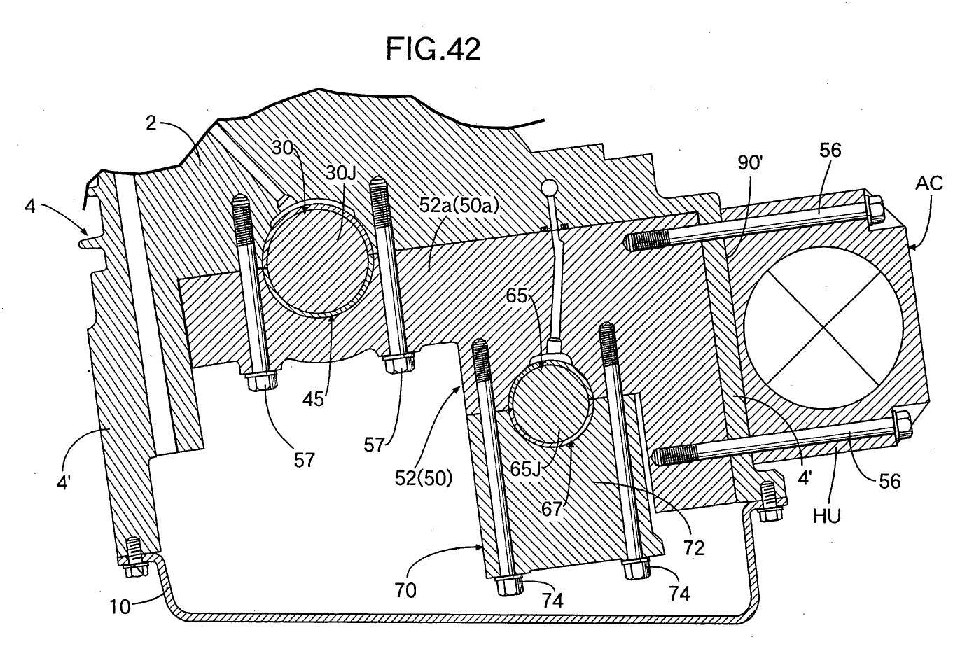

A sixteenth embodiment of the present invention is now explained by reference to FIG. 42.

FIG. 42 is a sectional view (a view corresponding to FIG. 6) of a part of an actuator AC mounted on an engine main body 1.

This sixteenth embodiment is a case in which crank bearing members 50 to 53 are bearing caps, a deep skirt part 4′ extends downward integrally from a crankcase 4 of a cylinder block 2, and an oil pan 10 is fixed to a lower end thereof. The crank bearing members 50 to 53, which are fixed to the crankcase 4, are housed within the deep skirt part 4′. The bearing members 50 and 52 (or 50 to 53) and a housing HU of the actuator AC are tightened together and fixed to the crankcase 4 via a plurality of securing bolts 56.

### Embodiment 17

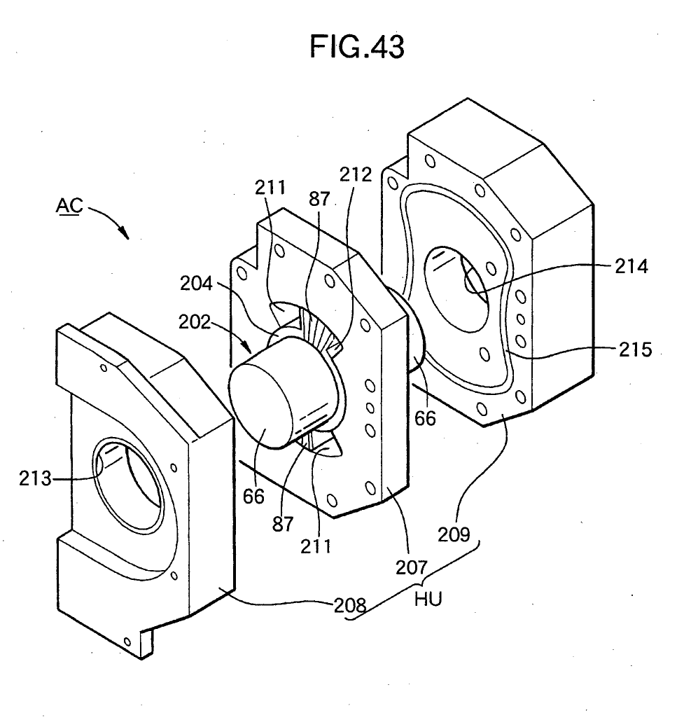

A seventeenth embodiment of the present invention is now explained by reference to FIGS. 43 to 45.

A vane type hydraulic actuator AC shown in FIG. 43 is for driving a control shaft 65 of a variable stroke characteristic engine, and has as main components a rotor 202 linked to an eccentric pin 65P of the control shaft 65, and a housing HU retaining this rotor 202 so that it can rotate through a predetermined angular range. The hydraulic actuator AC of this embodiment is used as a vane type hydraulic actuator for driving a variable stroke link mechanism LV of the variable stroke characteristic engine. This is particularly effective when the actuator AC is provided directly on the control shaft (when a load is directly applied).

The rotor 202 has a main body part 204 having a pair of vanes 87 projectingly provided on the outer periphery at an interval of 180° and vane shafts 66 and 66 provided on the left and right sides so as to project from opposite ends of the main body part 204. Furthermore, the housing HU is formed from a housing main body 207 housing the main body part 204 of the rotor 202, and left and right side plates 208 and 209 secured to left and right end faces of the housing main body 207. A first hydraulic chamber 211 and a second hydraulic chamber 212 defined by the vane 87 are formed in the housing main body 207, and the vane 87 (that is, the rotor 202) is rotated by hydraulic oil (engine oil) introduced into these hydraulic chambers 211 and 212 from a hydraulic source. Retaining holes 213 and 214 into which the vane shafts 66 and 66 of the rotor 202 are fitted are formed in the left and right side plates 208 and 209. In FIG. 43, a member denoted by the reference numeral 215 is a rubber seal fitted into an end face of the right side plate 209, and the same type of rubber seal is also mounted on the left side plate 208.

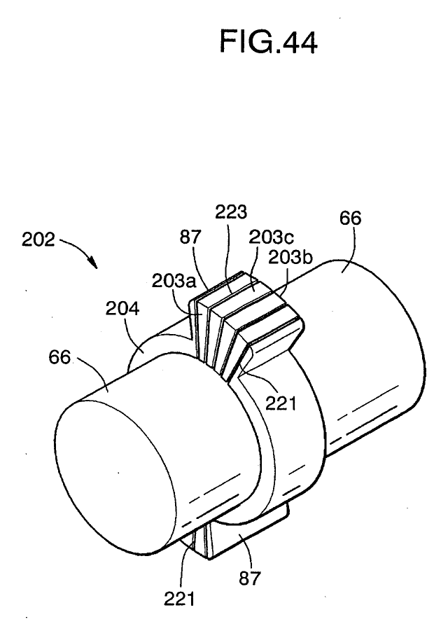

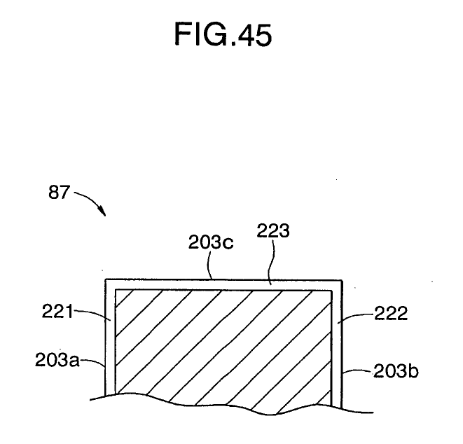

As shown in FIGS. 44 and 45, a plurality (5 in the illustrated example) of radial oil guide grooves (communication means) 221 and 222 going from the outer periphery side to the inner periphery side are formed in each of left and right end faces (end faces in the axial direction) 203a and 203b of the vane 87. Furthermore, communication grooves (communication means) 223 providing communication between the two oil guide grooves 221 and 222 are formed in the outer periphery 203c of the vane 87.

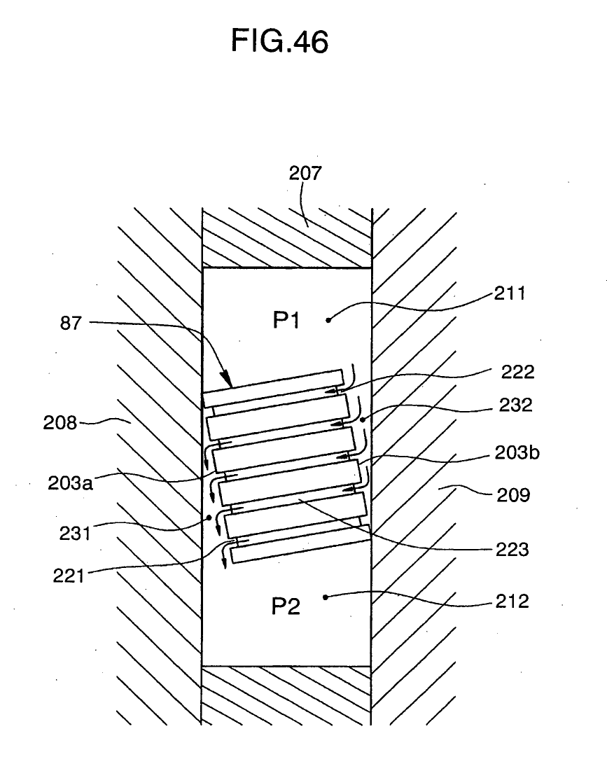

With regard to the vane type hydraulic actuator AC, a difference in pressure between the first hydraulic chamber 211 and the second hydraulic chamber 212 during operation becomes very large in some cases. For example, as shown in FIG. 46, an oil pressure P1 on the first hydraulic chamber 211 side becomes large relative to an oil pressure P2 of the second hydraulic chamber 212; in this state the vane 87 (that is, the rotor 202) tilts slightly in an anticlockwise direction in FIG. 46, wedge-shaped spaces 231 and 232 are formed between each of the left and right end faces 203a and 203b of the vane 87 and the left and right side plates 208 and 209, and high pressure hydraulic oil flows into the right wedge space 232 from the first hydraulic chamber 211.

A state in which the oil pressure P1 on the first hydraulic chamber 211 side is large relative to the oil pressure P2 of the second hydraulic chamber is a case in which a torque rotating the vane 87 to the first hydraulic chamber 211 side is inputted via each link or the control shaft by engine combustion pressure, etc. when the variable stroke link mechanism LV is operating, and it occurs particularly when the vane 87 is held at a predetermined position (in a center in the vane chamber, etc.).

In this seventeenth embodiment, since the oil guide grooves 221 and 222 are formed in the left and right end faces 203a and 203b of the vane 87, and the communication grooves 223 providing communication between the two oil guide grooves 221 and 222 are formed in the outer periphery 203c, as shown by the arrows in FIG. 46, high pressure hydraulic oil in the right wedge space 232 flows into the left wedge space 231 via these oil guide grooves 221 and 222 and the communication grooves 223. As a result, the difference in pressure between the left and right wedge spaces 231 and 232 becomes small, and the force that presses the left end face 203a of the vane 87 against the left side plate 208 becomes very weak.

Since the amount of hydraulic oil flowing from the right wedge space 232 to the left wedge space 231 is very small, there is almost no influence on the oil pressure P1 on the first hydraulic chamber 211 side or the oil pressure P2 on the second hydraulic chamber 112 side.

In this way, in the seventeenth embodiment, there are hardly any operational problems with the rotor 202 due to frictional force between the vane 87 and the left side plate 208, which is a problem with a conventional system, and there is also hardly any wear or galling of the vane 87 and the left side plate 208.

In FIG. 46, the tilt of the vane 87 and the wedge-shaped spaces 231 and 232 are exaggeratedly enlarged, but this is for making understanding of the explanation easy, and the tilt and gap are in reality very small.

### Embodiment 18

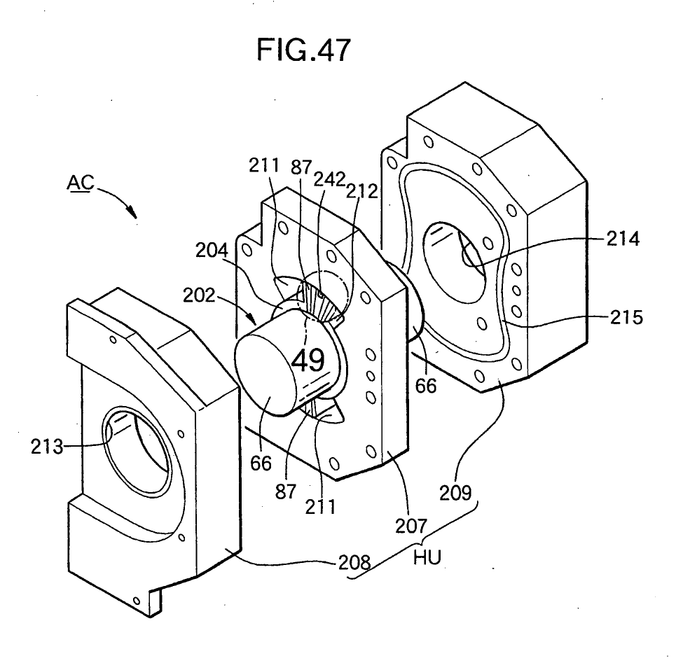

An eighteenth embodiment of the present invention is now explained by reference to FIGS. 47 to 50.

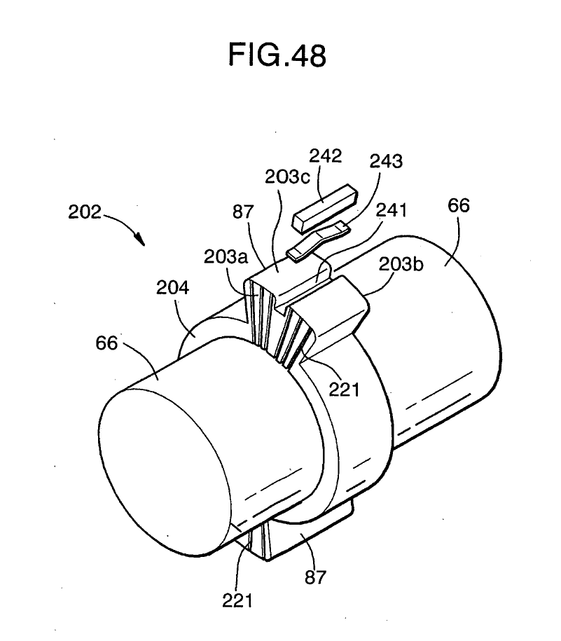

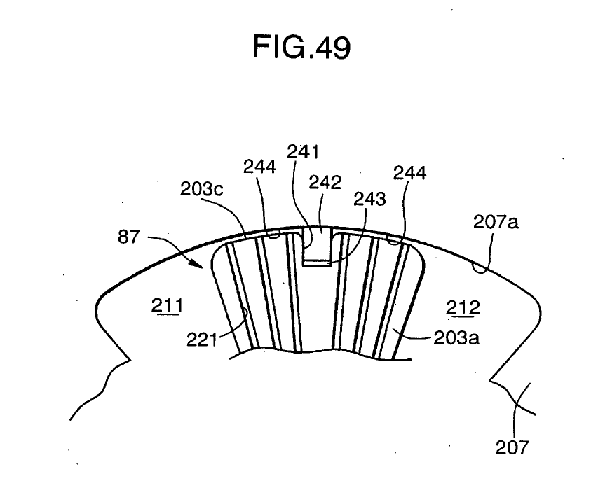

As shown in FIGS. 47 and 48, a vane type hydraulic actuator AC of this embodiment has substantially the same arrangement as that of the seventeenth embodiment, but is different in terms of the following points. That is, in the actuator AC of this eighteenth embodiment, as shown in FIG. 48, a rectangular groove 241 extending to left and right end faces 203a and 203b is formed in the middle in the peripheral direction of a vane 87, and an axial seal 242 and a seal spring 243 are housed in this rectangular groove 241. A plurality (6 each in the illustrated example) of radial oil guide grooves 221 and 222 going from the outer periphery to the inner periphery are formed in each of the left and right end faces 203a and 203b of the vane 87. As shown in FIG. 49, an outer periphery 203c of the vane 87 and an inner periphery 207a of a housing main body 207 face each other across a predetermined gap 244 (communication means), whereas the axial seal 242 urged by the seal spring 243 is in sliding contact with the inner periphery 207a of the housing main body 207.

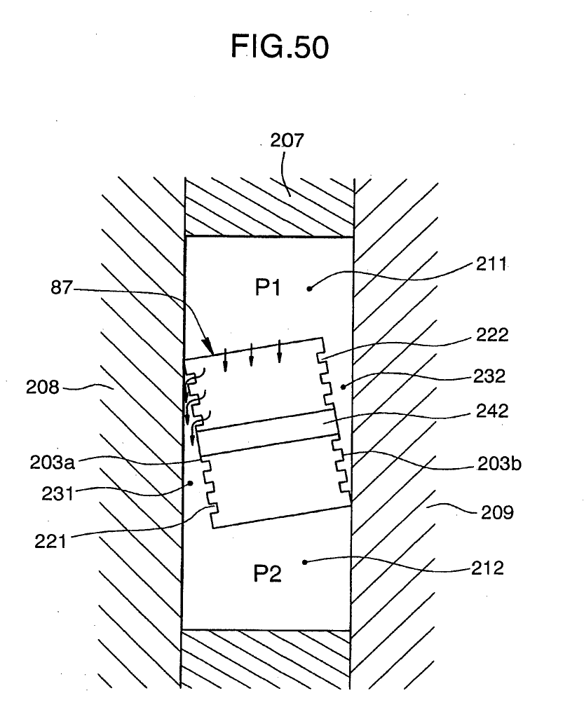

In this eighteenth embodiment, as shown in FIG. 50, an oil pressure P1 on a first hydraulic chamber 211 side becomes large relative to an oil pressure P2 on a second hydraulic chamber 212 side; when, in this state, the vane 87 (that is, a rotor 202) slightly tilts in an anticlockwise direction in the figure, as shown by the arrows in FIG. 50, high pressure hydraulic oil in the first hydraulic chamber 211 flows into a left wedge-shaped space 231 via the gap 244 and the left oil guide grooves 221. In this way, in the same manner as in the seventeenth embodiment, the difference in pressure between the left and right wedge-shaped spaces 231 and 232 becomes small, the force that presses the left end face 203a of the vane 87 against a left side plate 208 becomes very weak, hardly any operational problems occur with the rotor 202 and, in addition, there is hardly any wear or galling of the vane 87 and the left side plate 208 either.

### Embodiment 19

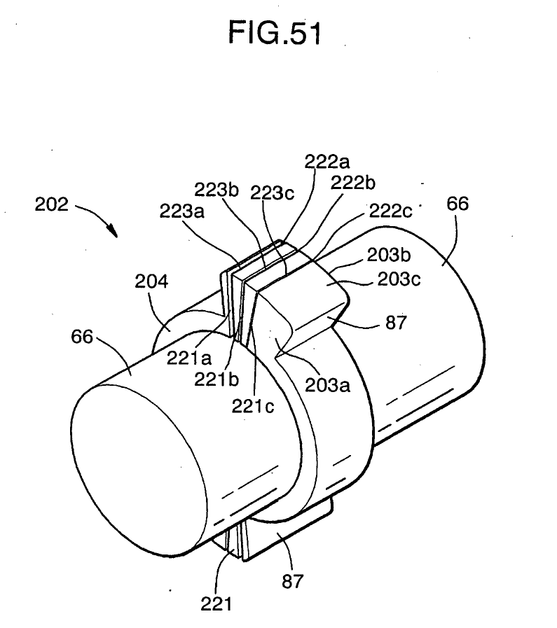

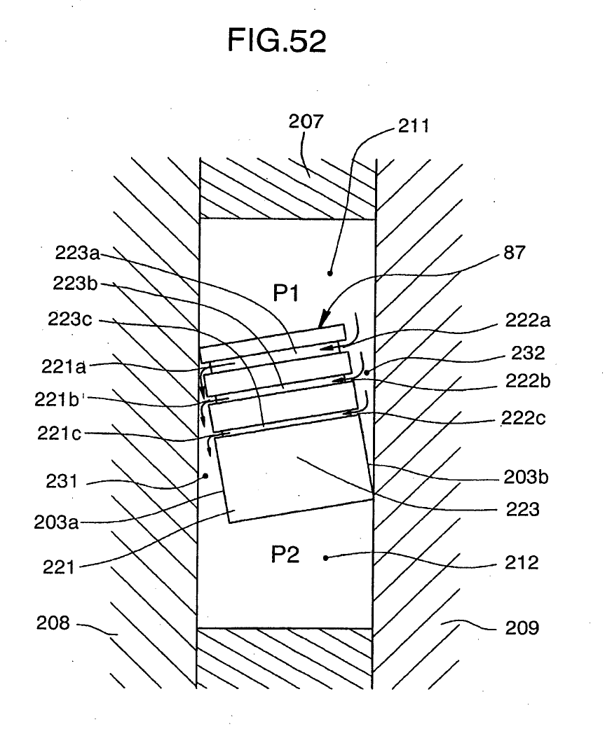

A nineteenth embodiment of the present invention is explained by reference to FIGS. 51 and 52.

This nineteenth embodiment has the same overall arrangement as that of the seventeenth embodiment, but the position, the number, etc. of oil guide grooves and communication grooves formed in a vane 87 are different. That is, in the vane 87 of this nineteenth embodiment, three each of oil guide grooves 221a to 221c and 222a to 222c and communication grooves 223a to 223c are formed from a first hydraulic chamber 211 side to the center of the vane 87. The width of these oil guide grooves 221a to 221c and 222a to 222c and the communication grooves 223a to 223c increases in going from a second hydraulic chamber 212 side to the first hydraulic chamber 211 side.

In this nineteenth embodiment, as shown in FIG. 52, an oil pressure P1 on the first hydraulic chamber 211 side becomes large relative to an oil pressure P2 on the second hydraulic chamber 112 side; when, in this state, the vane 87 (that is, a rotor 202) tilts slightly in an anticlockwise direction in the figure, as shown by the arrows in FIG. 52, high pressure hydraulic oil in a right wedge-shaped space 232 flows into a left wedge-shaped space 231 via both oil guide grooves 221a to 221c and 222a to 222c and the communication grooves 223a to 223c. In this process, since the width of the oil guide grooves 221a to 221c and 222a to 222c and the communication grooves 223a to 223c increases in going to the first hydraulic chamber 211 side, where the communication effect is high, the difference in oil pressure between the left and right wedge-shaped spaces 231 and 232 becomes small in a shorter period of time, and movement of the rotor 202 can be carried out more smoothly. Furthermore, in the nineteenth embodiment, since there are no oil guide grooves or communication grooves on the second hydraulic chamber 212 side, where the communication effect is low, it is possible to suppress any decrease in the strength and rigidity of the vane 87, and any decrease in the strength and rigidity, and reduce the amount of hydraulic oil flowing from the first hydraulic chamber 211 side to the second hydraulic chamber 212 side.

### Embodiment 20

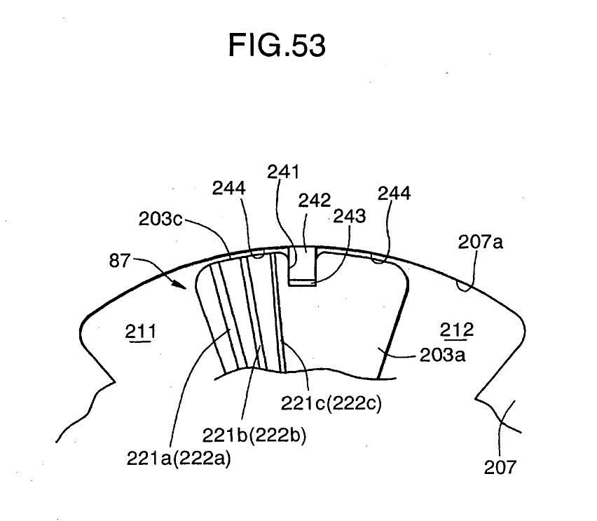

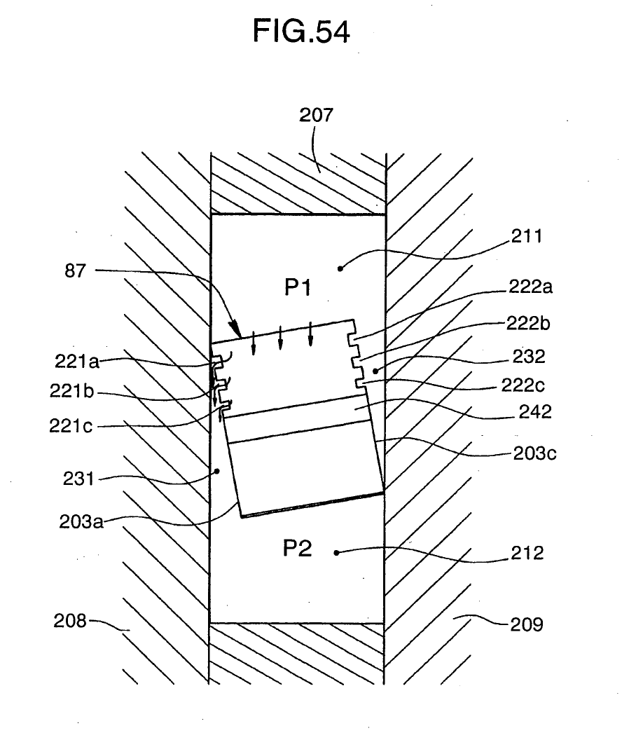

A twentieth embodiment of the present invention is now explained by reference to FIGS. 53 and 54.

This twentieth embodiment has the same overall arrangement as the eighteenth embodiment, but the position, number, etc. of oil guide grooves formed in a vane 87 are different. That is, in the vane 87 of this twentieth embodiment, three each of oil guide grooves 221a to 221c and 222a to 222c are formed from a first hydraulic chamber 211 side toward a position where an axial seal 242 is provided, and the width of these oil guide grooves 221a to 221c and 222a to 222c increases in going from the position where the axial seal 242 is provided to the first hydraulic chamber 211 side.

In this twentieth embodiment, as shown in FIG. 54, an oil pressure P1 on the first hydraulic chamber 211 side becomes large relative to an oil pressure P2 on a second hydraulic chamber 212 side, and when, in this state, the vane 87 (that is, a rotor 202) tilts slightly in an anticlockwise direction in the figure, as shown by the arrows in FIG. 54, high pressure hydraulic oil in the first hydraulic chamber 211 flows into a left wedge-shaped space 231 via a gap 244 and the left oil guide grooves 221a to 221c. In this process, since the width of the oil guide grooves 221a to 221c increases in going to the first hydraulic chamber 211 side, where the communication effect is high, the difference in oil pressure between the left and right wedge-shaped spaces 231 and 232 becomes small in a shorter period of time, and movement of the rotor 202 can be carried out more smoothly. Furthermore, in the twentieth embodiment, since there are no oil guide grooves on the second hydraulic chamber 212 side, where the communication effect is low, it is possible to suppress any decrease in the strength and rigidity of the vane 87, and reduce the amount of hydraulic oil flowing from the first hydraulic chamber 211 to the second hydraulic chamber 212.

The first to twentieth embodiments of the present invention are explained above, but the present invention is not limited to these embodiments, and various embodiments are possible within the scope of the present invention.

For example, in the embodiments above, the present invention is explained for a case in which it is applied to a variable compression ratio engine in which the top dead center of the piston is changed by changing the phase of the eccentric pin of the control shaft, but it can be applied to other variable stroke characteristic engines. Furthermore, in the embodiments above, the vane case is formed integrally with the housing, but a separate vane case may be fixed to a housing. Moreover, in the embodiments above, the present invention is explained for a case in which it is applied to an engine that is transversely mounted in a vehicle, but it is of course possible to apply it to an engine that is longitudinally mounted in a vehicle.

1. A variable stroke characteristic engine in which a piston (11) and a crankshaft (30) are linked to a control shaft (65) via a variable stroke link mechanism (LV), and the variable stroke link mechanism (LV) is operated by a hydraulic actuator (AC) that drives the control shaft (65) to thus make the stroke travel of the piston (11) variable,
characterized in that the hydraulic actuator (AC) comprises a housing (HU), a cover member (81, 82) covering an aperture of the housing (HU), a vane case (79) provided integrally within the housing (HU), and a vane shaft (66) housed within the vane case (79), and
the vane shaft (66) is formed integrally with the control shaft (65).

2. A variable stroke characteristic engine in which a piston (11) and a crankshaft (30) are linked to a control shaft (65) via a variable stroke link mechanism (LV), and the variable stroke link mechanism (LV) is operated by a hydraulic actuator (AC) that drives the control shaft (65) to thus make the stroke travel of the piston (11) variable,
characterized in that the hydraulic actuator (AC) comprises a housing (HU), a cover member (281, 282; 381) covering an aperture of the housing (HU), a vane case (79) provided integrally within the housing (HU), and a vane shaft (66) housed within the vane case (79), and the hydraulic actuator (AC) is provided on an end part of the control shaft (65), and
the vane shaft (66) is formed integrally with the end part of the control shaft (65).

3. A variable stroke characteristic engine in which a piston (11) and a crankshaft (30) are linked to a control shaft (65) via a variable stroke link mechanism (LV), and the variable stroke link mechanism (LV) is operated by a hydraulic actuator (AC) that drives the control shaft (65) to thus make the stroke travel of the piston (11) variable,
characterized in that the hydraulic actuator (AC) comprises a housing (HU), a cover member (181, 182) covering an aperture of the housing (HU), a vane case (79) provided integrally within the housing (HU), and a vane shaft (66) housed within the vane case (79), and the hydraulic actuator (AC) is provided between mutually opposing connecting end parts of a divided control shaft (65-1, 65-2), and
the cover member (181, 182) and the vane shaft (66) are formed integrally with the control shaft (65-1,65-2).

4. The variable stroke characteristic engine according to claim 3, wherein the cover member (181, 182) and the vane shaft (66) are secured integrally by a securing member (67) at a position not overlapping an eccentric pin (65P) of the control shaft (65-1, 65-2).

5. The variable stroke characteristic engine according to claim 3 or 4, wherein the cover member (181, 182) is bearingly supported on the housing (HU).

6. The variable stroke characteristic engine according to claim 1, 2 or 3, in which the variable stroke link mechanism (LV) is disposed to one side of the crankshaft (30) and the hydraulic actuator (AC) is a vane type hydraulic actuator disposed coaxially with the control shaft (65),
the vane type hydraulic actuator (AC) comprises the housing (HU), the vane shaft (66), which is integral with the control shaft (65) rotatably provided in the housing (HU) and has a vane (87) projectingly provided on the outer periphery, and a pair of vane oil chambers (86) between the housing (HU) and the vane shaft (66), the vane oil chambers (86) housing the vane (87), and
the pair of vane oil chambers (86) are arranged in a cylinder axis (L-L) direction of an engine main body (1) of the variable stroke characteristic engine (E).

7. The variable stroke characteristic engine according to claim 6, wherein the housing (HU) of the vane type hydraulic actuator (AC) is provided within a crankcase (4), the housing (HU) and the crankcase (4) are secured by a plurality of transverse securing members (56) from a direction perpendicular to the cylinder axis (L-L) of the engine main body (1), and at least some of these securing members (56) are provided between the pair of vane oil chambers (86) arranged in the cylinder axis (L-L) direction.

8. The variable stroke characteristic engine according to claim 6, wherein the housing (HU) of the vane type hydraulic actuator (AC) and the cover member (81, 82) covering the aperture of the housing (HU) are secured by a plurality of crankshaft-direction securing members (83) extending in the crankshaft (30) direction, and some of these crankshaft-direction securing members (83) are provided between the transverse securing members (56).

9. The variable stroke characteristic engine according to claim 7, wherein a hydraulic passage (88, 89) supplying hydraulic oil to the pair of vane oil chambers (86) is provided in the housing (HU) so as to be displaced in the crankshaft (30) direction with respect to the transverse securing member (56).

10. The variable stroke characteristic engine according to claim 6, wherein the cylinder axis (L-L) of the engine main body (1) is inclined toward one side relative to a vertical line (V-V), and the vane type hydraulic actuator (AC) is provided on the other side within a crankcase (4) beneath the crankshaft (30).

11. The variable stroke characteristic engine according to claim 1, 2 or 3, wherein the hydraulic actuator (AC) is disposed beneath the crankshaft (30) and comprises the housing (HU), the vane shaft (66) that is integral with the control shaft (65) rotatably provided on the housing (HU) and has a vane (87) projectingly provided on the outer periphery, and a pair of vane oil chambers (86) between the housing (HU) and the vane shaft (66), the vane oil chambers (86) housing the vane (87), and
the pair of vane oil chambers (86) are arranged in a direction perpendicular to a cylinder axis (L-L) of an engine main body (1) of the variable stroke characteristic engine (E).

12. The variable stroke characteristic engine according to claim 11, wherein the housing (HU) of the vane type hydraulic actuator (AC) is supported on a housing receiving part (73) provided integrally with a bearing block (70) supporting the control shaft (65), and the housing (HU) is secured via a securing member (74) to the housing receiving part (73) between the pair of vane oil chambers (86).

13. The variable stroke characteristic engine according to claim 11, wherein the cylinder axis (L-L) of the engine main body (1) is inclined to one side relative to a vertical line (V-V), a crankcase (4) of the engine main body (1) protrudes on one side relative to the cylinder block (2), and the vane type hydraulic actuator (AC) is housed within a crank camber (CC) of the protruding portion.

14. The variable stroke characteristic engine according to claim 1, 2 or 3, wherein the hydraulic actuator (AC) comprises the housing (HU), the vane shaft (66) rotatably provided in the housing (HU) and integral with the control shaft (65), and a vane (87) provided integrally with the outer periphery of the vane shaft (66) and dividing the interior of a vane oil chamber (86) formed between the housing (HU) and the vane shaft (66) into a plurality of control oil chambers (86a, 86b), and
the vane (87) is provided at a position that avoids the direction of a radial maximum load generated in the vane shaft (66).

15. The variable stroke characteristic engine according to claim 14 wherein, when the variable stroke characteristic engine is in the lowest low compression ratio state, the vane (87) is disposed in a direction perpendicular to the direction of maximum load.

16. The variable stroke characteristic engine according to claim 15, wherein the housing (HU) of the hydraulic actuator (AC) is secured to a housing receiving part (73) of a bearing block (70) in a direction opposite to the direction of maximum load, and a plurality of bearing walls (72) supporting the control shaft (65) and a linking member (71) joining these bearing walls (72) are formed integrally with the bearing block (70).

17. The variable stroke characteristic engine according to, wherein the vane type hydraulic actuator (AC) comprises urging force imparting means (BI) for imparting to the vane shaft (66) an urging force in a direction opposite to the direction of maximum load acting on the vane shaft (66).

18. The variable stroke characteristic engine according to claim 17, wherein the vane type hydraulic actuator (AC) is provided with control oil chambers (86a) for rotating the vane shaft (66) through a predetermined angular range, the control oil chambers (86a) opposing each other in the radial direction of the vane shaft (66), a communication oil path (99) communicating with the opposing control oil chambers (86a) is provided within the vane shaft (66) in a radial direction, and a communication state between the control oil chamber (86a) and the communication oil path (99) is restricted before a limit position in the rotational direction of the vane shaft (66).

19. The variable stroke characteristic engine according to claim 18 wherein, when the communication state between the opposing control oil chamber (86a) on one side and the communication oil path (99) is restricted, the communication state between the control oil chamber (86a) on the other side and the communication oil path (99) is maintained, and an oil path of a hydraulic circuit communicates with the control oil chamber (86a) on said other side.

20. The variable stroke characteristic engine according to claim 19, wherein a communication passage half (99A) on one side of the communication oil path (99) communicating with the opposing control oil chamber (86a) on one side and a communication passage half (99B) on the other side of the communication oil path (99) communicating with the opposing control oil chamber (86a) on the other side are each formed linearly, and the communication passage half (99B) on said other side is formed so as to bend relative to the communication passage half (99A) on said one side at a predetermined angle in a central part of the vane shaft (66).
